(19) United States
(12) Patent Application Publication
(10) Pub. No.: US 2007/0072787 A1
(43) Pub. Date: Mar. 29, 2007

(54) Stable particulate composition comprising bleach catalysts

(76) Inventors: Menno Hazenkamp, Riehen (CH); Petr Kvita, Reinach (CH); Johannes Nagel, Schworstadt (DE); Heinz-Udo Bertram, Rheinfelden (DE); Pierre Dreyer, Blodelsheim (DE); Peter Weingartner, Diegten (CH)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/557,223

(22) PCT Filed: May 12, 2004
(86) PCT No.: PCT/EP04/50766

§ 371 Date: Nov. 17, 2005

(30) Foreign Application Priority Data
May 21, 2003 (EP) 03101450.9
Jan. 15, 2004 (EP) 04100105.8

(51) Int. Cl. C11D 17/00

(52) U.S. Cl. 510/446; 510/314

(57) ABSTRACT

The present Application relates to particulate compositions, especially granules, comprising finely particulate bleach catalysts, alkali metal and/or alkaline earth metal and/or aluminium salts, water-soluble binders having sealing properties and water, and to the preparation of such granules, and also to washing compositions comprising such granules.

The present invention relates to particulate compositions, especially granules, comprising finely particulate bleach catalysts, alkali metal salts and/or alkaline earth metal salts and/or aluminium salts, water-soluble binders having sealing properties and water, and to the preparation of such granules, as well as to washing compositions comprising such granules.

The particulate compositions of bleach catalysts according to the invention are preferably used in bleach-containing washing compositions and bleach additives. Use of the catalysts is considered successful when they are inactive in the washing composition for the entire (storage) time, and when they dissolve, and at the same time catalyse the generation of hydrogen peroxide, only when they are used in the washing liquor. This places a high demand on the granules, which should encapsulate the catalyst as well as is possible prior to use and should prevent contact thereof with the bleaching agent (for example percarbonate) so as to preclude premature deactivation of the entire bleaching system. A hydrophobic formulation cannot be used for the granules since they need to dissolve in the washing liquor within a few minutes in order for the bleaching system to become fully active. A further difficulty is that washing compositions are, in their nature, strongly hygroscopic and, as a result, the bleach catalyst granules may start to dissolve prematurely, that is to say during storage in the washing composition packaging.

The catalyst is best protected by embedding it in a dense granule matrix. The matrix must comprise a meltable or thermoplastic component (sintering component) that fills all of the capillaries in the granule matrix, so as to prevent the penetration of water and other components of the washing composition and thereby prevent the granules starting to dissolve prematurely. The sintering component must, on the other hand, be readily soluble in water in order to meet the requirement of rapid dissolution in the washing bath.

It has now, surprisingly, been found that the action of the bleach catalysts is substantially enhanced by the active substance having a very fine particle size, the bleaching action being additionally enhanced by the addition of alkali metal salts and/or alkaline earth metal salts and/or aluminium salts, without, at the same time, the storage stability of the granules being impaired.

The present invention relates to particulate compositions containing

(a) from 1 to 40% by weight, based on the total weight of the particulate composition, of at least one finely particulate bleach catalyst having an average particle size (X₅₀) of <35 μm;

(b) from 0 to 65% by weight, based on the total weight of the particulate composition, of at least one alkali metal salt and/or alkaline earth metal salt and/or aluminium salt;

(c) from 5 to 90% by weight, based on the total weight of the particulate composition, of at least one water-soluble binder having sealing properties;

(d) from 0.05 to 12% by weight, based on the total weight of the particulate composition, water;

(e) from 0 to 70% by weight, based on the total weight of the particulate composition, of at least one water-soluble polymer and/or dispersing agent;

(f) from 0 to 90% by weight, based on the total weight of the particulate composition, of at least one filler;

(g) from 0 to 8% by weight, based on the total weight of the particulate composition, of at least one plasticizer;

(h) from 0 to 50% by weight, based on the total weight of the particulate composition, of at least one white pigment;

(i) from 0 to 5% by weight, based on the total weight of the particulate composition, of at least one water-soluble or water-dispersible dye/pigment;

(j) from 0 to 5% by weight, based on the total weight of the particulate composition, of at least one anti-adherent and/or lubricant;

(k) from 0 to 20% by weight, based on the total weight of the particulate composition, of at least one further additive selected from optical brighteners; suspending agents for dirt; pH regulators; foam regulators; salts for regulating the spray-drying and the granulating properties; fragrances; preservatives; wetting agents; dissolution accelerators; disintegrants, such as powdered or fibrous cellulose; antistatic agents; fabric conditioners; enzymes; toning agents; non-ionic surfactants; and polymers which, during the washing of textiles, prevent staining caused by dyes in the washing liquor which have been released from the textiles under the washing conditions.

With the particulate compositions according to the invention it has been possible for the above requirements, which are in themselves entirely contradictory, to be met and, in addition, for a means to be found of also providing, in a stable granulate, catalysts that are sparingly soluble in water, with the result that they are fully active in use. The particulate compositions according to the invention are in addition distinguished by good storage stability.

The finely particulate bleach catalysts preferably have an average particle size (X₅₀) of <20 μm. The average particle size is especially in the range from 0.01 to 10 μm. The average particle size is more especially in the range from 0.01 to 2.5 μm. 90% of the bleach catalyst particles generally have a particle size of <7 μm, preferably <5 μm.

There are suitable as the bleach catalysts [component (a)] all known and customary bleach catalysts. The bleach catalysts disclosed in EP 630 946, U.S. Pat. No. 5,965,506, U.S. Pat. No. 5,733,341, WO 97 19162, U.S. Pat. No. 6,486,110, U.S. Pat. No. 6,562,775, EP 955 289, WO 00 53574, WO 00 53712, WO 01 05925 and EP 02 088 289 are especially suitable.

Attention is drawn here to the bleach catalysts of formulae (1) to (4): 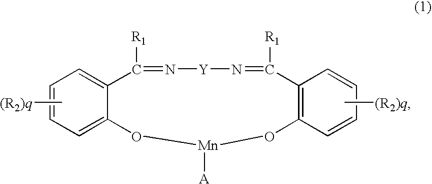
wherein

each R₁, independently of the other, is hydrogen; C₁-C₁₂alkyl unsubstituted or substituted by halogen, C₁-C₄alkoxy, phenyl, carboxyl, C₁-C₄alkoxycarbonyl or mono- or di-C₁-C₄alkylated amino groups; C₄-C₈cycloalkyl unsubstituted or substituted by C₁-C₄alkyl or by C₁-C₄alkoxy; phenyl unsubstituted or substituted by C₁-C₄alkyl, C₁-C₄alkoxy, C₂-C₅-alkanoylamino, nitro, sulfo or mono- or di-C₁-C₄alkylated amino groups; or naphthyl unsubstituted or substituted by C₁-C₄alkyl, C₁-C₄alkoxy, C₂-C₅alkanoylamino, nitro, sulfo or mono- or di-C₁-C₄alkylated amino groups;

each R₂, independently of the other(s), is hydrogen; hydroxy; C₁-C₁₂alkyl unsubstituted or substituted by halogen, C₁-C₄alkoxy, phenyl, carboxyl, C₁-C₄alkoxycarbonyl or by a mono- or di-C₁-C₄alkylated amino group; C₁-C₈alkoxy unsubstituted or substituted by halogen, C₁-C₄alkoxy, phenyl, carboxyl, C₁-C₄alkoxycarbonyl or by a mono- or di-C₁-C₄-alkylated amino group; halogen; N(C₁-C₄alkyl)₂ or NH(C₁-C₄alkyl) in which at least one alkyl group may be substituted by halogen, C₁-C₄alkoxy, phenyl, carboxyl, C₁-C₄alkoxy-carbonyl or by a mono- or di-C₁-C₄alkylated amino group; N^{⊕}(C₁-C₄alkyl)₃ or NH^{⊕}(C₁-C₄alkyl)₂ in which at least one alkyl group may be substituted by halogen, C₁-C₄alkoxy, phenyl, carboxyl, C₁-C₄alkoxycarbonyl or by a mono- or di-C₁-C₄alkylated amino group; or a water-soluble group;

Y is linear or branched alkylene of formula —[C(R₁)₂]ₘ, wherein m is a number from 1 to 8 and each R₁ independently of the other(s), is as defined hereinbefore; —CX═CX—, wherein X is cyano, linear or branched C₁-C₈alkyl or di(linear or branched C₁-C₈alkyl)amino; —(CH₂)ᵣ—NRᵣ—(CH₂)ᵣ—, wherein R₁ is as defined hereinbefore and r is 1, 2, 3 or 4; or a 1,2-cyclohexylene or phenylene group of formula: 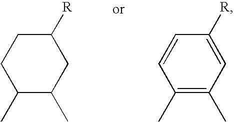
wherein R is hydrogen, CH₂OH, CH₂NH₂ or SO₃M, wherein M is hydrogen, an alkali metal ion, ammonium or a cation that is formed from an amine,

each q, independently of the other, is 0, 1, 2 or 3; and

A is an anion;

bleach catalysts of formula (2) 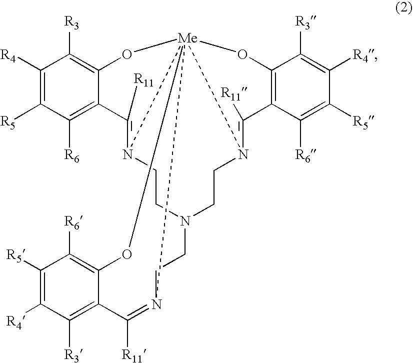
wherein

R₃, R₄, R₅, R₆, R₃′, R₄′, R₅′, R₆′, R₃″, R₄″, R₅″ and R₆″ are each independently of the others hydrogen; cyano; halogen; —SO₃M; —SO₂NH₂; —SO₂NHR₇; —SO₂N(R₇)₂; —OR₇; —COOR₇; nitro; linear or branched C₁-C₈alkyl; linear or branched partially fluorinated or perfluorinated C₁-C₈alkyl; —NHR₈; —NR₈R₉; —N^{⊕}R₈R₉R₁₂ or linear or branched C₁-C₈alkyl-R₁₀;

M is hydrogen; an alkali metal cation; an alkaline earth metal cation; ammonium or an organic ammonium cation;

R₇ is hydrogen; or linear or branched C₁-C₄alkyl;

R₁₀ is OR₇; —COOR₇; —NH₂; —NHR₈; —NR₈R₉ or —N^{⊕}R₈R₉R₁₂;

R₈, R₉ and R₁₂ are the same or different and each is linear or branched C₁-C₁₂alkyl; or R₈ and R₉ together with the nitrogen atom linking them form a 5-, 6- or 7-membered ring that may contain further hetero atoms;

R₁₁, R₁₁′ and R₁₁″ are each independently of the others hydrogen; linear or branched C₁-C₈-alkyl or aryl, and

Me is a transition metal;

bleach catalysts of formula (3)

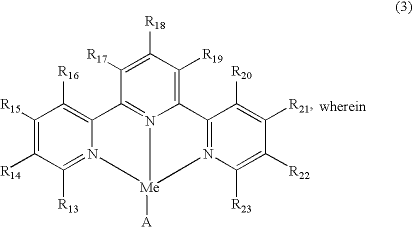

R₁₃, R₁₄, R₁₅, R₁₆, R₁₇, R₁₈, R₁₉, R₂₀, R₂₁, R₂₂ and R₂₃ are each independently of the others hydrogen; unsubstituted or substituted C₁-C₁₈alkyl; unsubstituted or substituted aryl; cyano; halogen; nitro; —COOR₂₄; —SO₃R₂₄,
wherein R₂₄ is in each case hydrogen; a cation; unsubstituted or substituted C₁-C₁₈-alkyl or unsubstituted or substituted aryl;

—SR₂₅; —SO₂R₂₅; —OR₂₅,
wherein R₂₅ is in each case hydrogen; or unsubstituted or substituted C₁-C₁₈alkyl; —NR₂₆R₂₇; —(C₁-C₆alkylene)-NR₂₆R₂₇; —N^{⊕}R₂₆R₂₇R₂₈; —(C₁-C₆alkylene)-N^{⊕}R₂₆R₂₇R₂₈; —N(R₂₅)—(C₁-C₆alkylene)-NR₂₆R₂₇; —N[(C₁-C₆alkylene)-NR₂₆R₂₇]₂; —N(R₂₅)—(C₁-C₆alkylene)-N^{⊕}R₂₆R₂₇R₂₈; —N[(C₁-C₆alkylene)-N^{⊕}R₂₆R₂₇R₂₈]₂; —N(R₂₅)—NR₂₆R₂₇; or —N(R₂₅)—N^{⊕}R₂₆R₂₇R₂₈,
wherein R₂₆, R₂₇ and R₂₈ are each independently of the others hydrogen;

unsubstituted or substituted C₁-C₁₈alkyl; or unsubstituted or substituted aryl; or wherein R₂₆ and R₂₇, together with the nitrogen atom linking them, form an unsubstituted or substituted 5-, 6- or 7-membered ring that may contain further hetero atoms,

Me is a transition metal and

A is an anion;

bleach catalysts of formula (4) 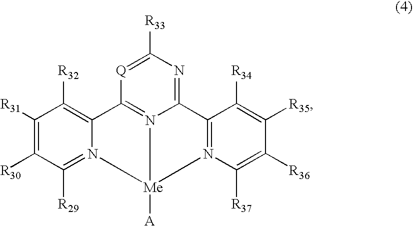
wherein

Q is N or CR₃₈;

R₂₉, R₃₀, R₃₁, R₃₂, R₃₃, R₃₄, R₃₅, R₃₆, R₃₇ and R₃₈ are each independently of the others hydrogen; unsubstituted or substituted C₁-C₁₈alkyl; unsubstituted or substituted aryl; cyano; halogen; nitro; —COOR₃₉; —SO₃R₃₉,
wherein R₃₉ is in each case hydrogen; a cation; unsubstituted or substituted C₁-C₁₈alkyl or unsubstituted or substituted aryl;

—SR₄₀; —SO₂R₄₀; —OR₄₀,
wherein R₄₀ is in each case hydrogen; unsubstituted or substituted C₁-C₁₈alkyl or unsubstituted or substituted aryl; —NR₄₁R₄₂; —(C₁-C₆alkylene)-NR₄₁R₄₂; —N^{⊕}R₄₁R₄₂R₄₃; —(C₁-C₆alkylene)-N^{⊕}R₄₁R₄₂R₄₃; —N(R₄₀)—(C₁-C₆alkylene)-NR₄₁R₄₂; —N[(C₁-C₆alkylene)-NR₄₁R₄₂]₂; —N(R₄₀)—(C₁-C₆alkylene)-N^{⊕}R₄₁R₄₂R₄₃; —N[(C₁-C₆alkylene)-N^{⊕}R₄₁R₄₂R₄₃]₂; —N(R₄₀)—NR₄₁R₄₂; or —N(R₄₀)—N^{⊕}R₄₁R₄₂R₄₃,
wherein R₄₀ is as defined hereinbefore; and

wherein R₄₁, R₄₂ and R₄₃ are each independently of the others hydrogen; unsubstituted or substituted C₁-C₁₈alkyl or unsubstituted or substituted aryl; or R₄, and R₄₂, together with the nitrogen atom linking them, form an unsubstituted or substituted 5-, 6- or 7-membered ring that may contain further hetero atoms;

Me is a transition metal and

A is an anion.

The ligands in the metal complexes of formulae (3) and (4) that are substituted by hydroxyl can also be formulated as compounds having a pyridone structure, in accordance with the following scheme (illustrated here by the example of a terpyridine substituted by hydroxy in the 4′ position):

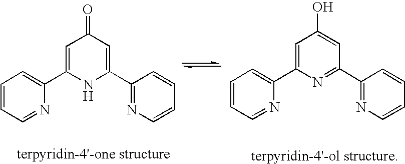

The special position of the above hydroxy-substituted terpyridines within the terpyridine family is due to the fact that these ligands can be be deprotonated and are therefore able to function as anionic ligands.

Accordingly, there are generally to be understood by hydroxyl-substituted terpyridines also those having a corresponding pyridone structure.

Suitable substituents for the alkyl groups, aryl groups, alkylene groups or 5-, 6- or 7-membered rings include especially C₁-C₄alkyl; C₁-C₄alkoxy; hydroxyl; sulfo; sulfato; halogen; cyano; nitro; carboxyl; amino; phenyl unsubstituted or substituted by N-mono- or N,N-di-C₁-C₄alkylamino substituted by hydroxy in the alkyl moiety, N-phenylamino, N-naphthyl-amino, phenyl, phenoxy or by naphthyloxy.

The alkyl radicals mentioned for the compounds of formulae (1), (2), (3) and (4) are, for example, straight-chain or branched alkyl radicals, such as methyl, ethyl, n-propyl, isopropyl, n-butyl, sec-butyl, iso-butyl, tert-butyl or straight-chain or branched pentyl, hexyl, heptyl or octyl. The mentioned alkyl radicals may be unsubstituted or may be substituted, for example, by hydroxyl, C₁-C₄alkoxy, sulfo or sulfato, especially by hydroxyl. Preference is given to the corresponding unsubstituted alkyl radicals. Special preference is given to methyl and ethyl, especially methyl.

As aryl radicals for the compounds of formulae (1), (2), (3) and (4) there come into consideration, for example, phenyl or naphthyl unsubstituted or substituted by C₁-C₄alkyl, C₁-C₄alkoxy, halogen, cyano, nitro, carboxyl, sulfo, hydroxyl, amino, N-mono- or N,N-di-C₁-C₄alkylamino unsubstituted or substituted by hydroxy in the alkyl moiety, N-phenylamino, N-naphthylamino, in which the amino groups may be quatemised, phenyl, phenoxy or by naphthyloxy. Preferred substituents are C₁-C₄alkyl, C₁-C₄alkoxy, phenyl or hydroxy. Special preference is given to the corresponding phenyl radicals.

The C₁-C₆alkylene groups mentioned for the compounds of formulae (1), (2), (3) and (4) include, for example, straight-chain or branched alkylene radicals, such as methylene, ethylene, n-propylene or n-butylene. Preference is given to C₁-C₄alkylene groups. The mentioned alkylene radicals may be unsubstituted or substituted, for example by hydroxyl or by C₁-C₄alkoxy.

For the compounds of formulae (1), (2), (3) and (4), halogen is preferably chlorine, bromine or fluorine, with special preference being given to chlorine.

As cations for the compounds of formulae (1), (2), (3) and (4) there come into consideration, for example, alkali metal cations, such as lithium, potassium or, especially, sodium, alkaline earth metal cations, such as magnesium or calcium, and ammonium cations. The corresponding alkali metal cations, especially sodium, are preferred.

Suitable metal ions for Me for the compounds of formulae (2), (3) and (4) include, for example, manganese in oxidation states II-V, titanium in oxidation states III and IV, iron in oxidation states I to IV, cobalt in oxidation states I to II, nickel in oxidation states I to III and copper in oxidation states I to III. Of those, special preference is given to manganese, especially manganese in oxidation states II to IV, more especially in oxidation state II. Also of interest are titanium IV, iron II-IV, cobalt II-III, nickel II-III and copper II-III, especially iron II-IV.

As anion A for the compounds of formulae (1), (2), (3) and (4) there come into consideration, for example, R′COO⁻; ClO₄⁻; BF₄⁻; PF₆⁻; R′SO₃⁻; R′SO₄⁻; SO₄²⁻—; NO₃⁻; F⁻; Cl⁻; Br⁻ or I⁻, wherein R′ is hydrogen or unsubstituted or substituted C₁-C₁₈alkyl or aryl. For R′ as C₁-C₁₈alkyl or aryl, the definitions and preferred meanings given hereinbefore and hereinafter apply.

Especially preferably, R′ is hydrogen; C₁-C₄alkyl; phenyl or sulfophenyl, especially hydrogen or 4-sulfophenyl. The charge of the anion A is accordingly especially 1⁻ or 2⁻, more especially 1⁻.

A can also be a customary organic counter-ion, for example citrate, oxalate or tartrate. Preference is given to bleach catalysts of formula (1′) 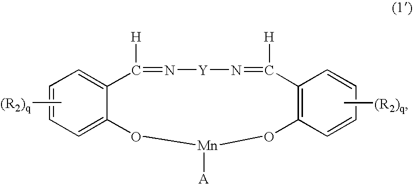
wherein

each R₂, independently of the other(s), is hydroxy; C₁-C₄alkyl unsubstituted or substituted by halogen, C₁-C₄alkoxy, phenyl, carboxyl, C₁-C₄alkoxycarbonyl or by a mono- or di-C₁-C₄alkylated amino group; C₁-C₄alkoxy unsubstituted or substituted by halogen, C₁-C₄alkoxy, phenyl, carboxyl, C₁-C₄alkoxycarbonyl or by a mono- or di-C₁-C₄alkylated amino group; halogen; N(C₁-C₄alkyl)₂ or NH(C₁-C₄alkyl) in which at least one alkyl group may be substituted by halogen, C₁-C₄alkoxy, phenyl, carboxyl, C₁-C₄alkoxycarbonyl or by a mono- or di-C₁-C₄alkylated amino group; or a water-soluble group;

Y is linear or branched alkylene of formula —[C(R₁)₂]ₘ, wherein m is a number from 1 to 4 and each R₁, independently of the other(s), is as defined hereinbefore; —(CH₂)ᵣ—NR₁—(CH₂)ᵣ— wherein R₁ is as defined hereinbefore and r is 1 or 2; or a 1,2-cyclohexylene or phenylene group of formula: 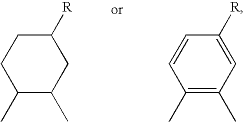
wherein R is hydrogen, CH₂OH, CH₂NH₂ or SO₃M, wherein M is hydrogen, an alkali metal ion, ammonium or a cation that is formed from an amine,

each q, independently of the other, is 0, 1 or 2; and

A is F⁻; Cl⁻; Br⁻; I⁻; perchlorate; sulfate; nitrate; OH⁻; BF₄⁻; PF₆⁻ or carboxylate.

A bleach catalyst of formula (1) and (1′) to which special preference is given is the bleach catalyst of formula (1a):

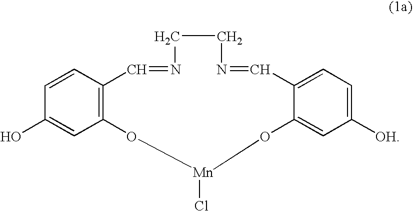

Preference is given likewise to bleach catalysts of formula (2) wherein

R₃, R₄, R₅, R₆, R₃′, R₄′, R₅′, R₆′, R₃″, R₄″, R₅″ and R₆″ are each independently of the others hydrogen; cyano; Cl; —SO₃M,
wherein M is hydrogen; an alkali metal cation; an alkaline earth metal cation; ammonium; an organic ammonium cation; nitro; linear or branched C₁-C₄alkyl; linear or branched partially fluorinated or perfluorinated C₁-C₄alkyl; —NHR₈; —NR₈R₉; —N^{⊕}R₈R₉R₁₂; or linear or branched C₁-C₄alkyl-R₁₀,
wherein R₁₀ is —OR₇; —COOR₇; —NH₂; —NHR₈; —NR₈R₉; or —N^{⊕}R₈R₉R₁₂; and

wherein R₈, R₉ and R₁₂, are identical or different and are each linear or branched C₁-C₄alkyl.

Bleach catalysts of formula (2) to which special preference is given are 1:1 Me(III) complexes of formula (2′) 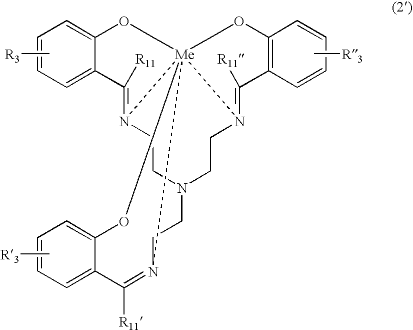
wherein Me is Mn or Fe,

R₃, R₃′ and R₃″ are each independently of the others hydrogen; C₁-C₄alkyl; C₁-C₄alkoxy; hydroxy; nitro; NHR₆; NR₆R₇ or —N^{⊕}R₅R₆R₇, wherein R₅, R₆ and R₇ are each independently of the others C₁-C₄alkyl.

An especially preferred bleach catalyst of formula (2) and (2′) is the bleach catalyst of formula (2a):

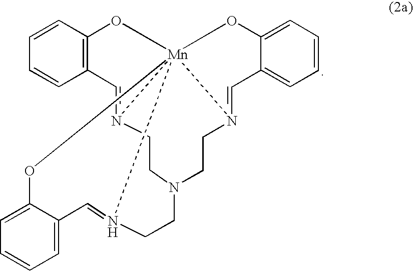

Preference is given likewise to bleach catalysts of formula (3) wherein

R₁₃, R₁₄, R₁₅, R₁₆, R₁₇, R₁₈, R₁₉, R₂₀, R₂₁, R₂₂ and R₂₃ are each independently of the others. hydrogen; unsubstituted or substituted C₁-C₄alkyl; unsubstituted or substituted aryl; cyano; halogen; nitro; —COOR₂₄; —SO₃R₂₄,
wherein R₂₄ is in each case hydrogen; a cation; unsubstituted or substituted C₁-C₄alkyl or unsubstituted or substituted aryl;

—SR₂₅; —SO₂R₂₅; —OR₂₅,
wherein R₂₅ is in each case hydrogen; unsubstituted or substituted C₁-C₄alkyl or unsubstituted or substituted aryl; —NR₂₆R₂₇; —(C₁-C₄alkylene)-NR₂₆R₂₇; —N^{⊕}R₂₆R₂₇R₂₈; —(C₁-C₄alkylene)-N^{⊕}R₂₆R₂₇R₂₈; —N(R₂₅)—(C₁-C₄alkylene)-NR₂₆R₂₇; —N[(C₁-C₄alkylene)-NR₂₆R₂₇]₂; —N(R₂₅)—(C₁-C₄alkylene)-N^{⊕}R₂₆R₂₇R₂₈; —N[(C₁-C₄alkylene)-N^{⊕}R₂₆R₂₇R₂₈]₂; —N(R₂₅)—NR₂₆R₂₇; or —N(R₂₅)—N^{⊕}R₂₆R₂₇R₂₈,
wherein R₂₅ is as defined hereinbefore; and
wherein R₂₆, R₂₇ and R₂₈ are each independently of the others hydrogen; or unsubstituted or substituted C₁-C₄alkyl or unsubstituted or substituted aryl; or R₂₆ and R₂₇, together with the nitrogen atom linking them, form an unsubstituted or substituted 6-membered ring that may contain further hetero atoms, especially a piperazine ring.

Bleach catalysts of formula (3) to which greater preference is given are 1:1 Me(III) complexes of formula (3′) 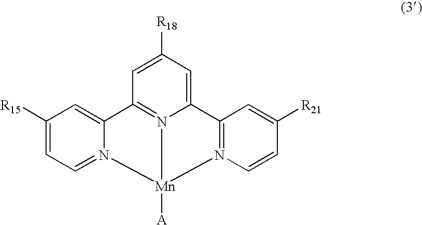
wherein

R₁₈ is unsubstituted or substituted C₁-C₄alkyl; unsubstituted or substituted aryl; cyano; halogen; nitro; —COOR₂₄; —SO₃R₂₄,
wherein R₂₄ is in each case hydrogen; a cation; unsubstituted or substituted C₁-C₄alkyl or unsubstituted or substituted aryl;

—SR₂₅; —SO₂R₂₅; —OR₂₅,
wherein R₂₅ is in each case hydrogen; unsubstituted or substituted C₁-C₄alkyl or unsubstituted or substituted aryl; —NR₂₆R₂₇; —(C₁-C₄alkylene)-NR₂₆R₂₇; —N^{⊕}R₂₆R₂₇R₂₈; —(C₁-C₄alkylene)-N^{⊕}R₂₆R₂₇R₂₈; —N(R₂₅)—(C₁-C₄alkylene)-NR₂₆R₂₇; —N[(C₁-C₄alkylene)-NR₂₆R₂₇]₂; —N(R₂₅)—(C₁-C₄alkylene)-N^{⊕}R₂₆R₂₇R₂₈; —N[(C₁-C₄alkylene)-N^{⊕}R₂₆R₂₇R₂₈]₂; —N(R₂₅)—NR₂₆R₂₇; or —N(R₂₅)—N^{⊕}R₂₆R₂₇R₂₈,
wherein R₂₅ is as defined hereinbefore; and
wherein R₂₆, R₂₇ and R₂₈ are each independently of the others hydrogen; or unsubstituted or substituted C₁-C₄alkyl or unsubstituted or substituted aryl; or R₂₆ and R₂₇, together with the nitrogen atom linking them, form an unsubstituted or substituted 6-membered ring that may contain further hetero atoms, especially a piperazine ring.

R₁₅ and R₂₁, are each independently of the other hydrogen or have the meanings given for R₁₈, and

A is F⁻; Cl⁻; Br⁻; I⁻; perchlorate; sulfate; nitrate; OH⁻; BF₄⁻; PF₆⁻ or carboxylate.

Bleach catalysts of formula (3′) to which special preference is given are those wherein

R₁₈ is C₁-C₄alkoxy; hydroxy; N-mono- or N,N-di-C₁-C₄alkylamino substituted by hydroxy in the alkyl moiety; or an unsubstituted or C₁-C₄alkyl-substituted pyrrolidine, piperidine, piperazine, morpholine or azepane ring, and

R₁₅ and R₂₁, are each independently of the other hydrogen; C₁-C₄alkoxy; hydroxy; N-mono- or N,N-di-C₁-C₄alkylamino substituted by hydroxy in the alkyl moiety; or an unsubstituted or C₁-C₄alkyl-substituted pyrrolidine, piperidine, piperazine, morpholine or azepane ring.

Bleach catalysts of formula (3) and (3′) to which very special preference is given are the bleach catalysts of formulae (3a) and (3b):

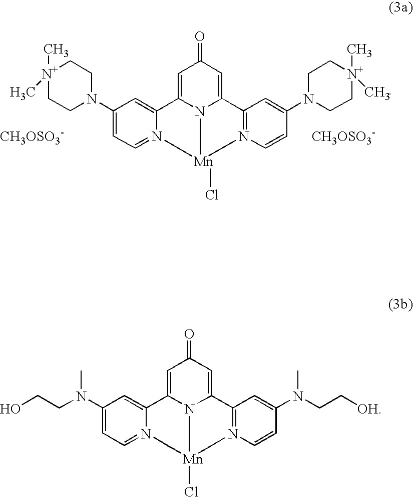

Preference is given likewise to bleach catalysts of formula (4) wherein

Q is N or CR₃₈,

R₂₉, R₃₀, R₃₁, R₃₂, R₃₃, R₃₄, R₃₅, R₃₆, R₃₇ and R₃₈ are each independently of the others hydrogen; unsubstituted or substituted C₁-C₄alkyl; unsubstituted or substituted aryl; cyano; halogen; nitro; —COOR₃₉; —SO₃R₃₉,
wherein R₃₉ is in each case hydrogen; a cation; or unsubstituted or substituted C₁ -C₄alkyl or unsubstituted or substituted aryl;

—SR₄₀; —SO₂R₄₀; —OR₄₀,
wherein R₄₀ is in each case hydrogen; unsubstituted or substituted C₁-C₄alkyl or unsubstituted or substituted aryl; —NR₄₁R₄₂; —(C₁-C₄alkylene)-NR₄₁R₄₂; —N^{⊕}R₄₁R₄₂R₄₃; —(C₁-C₄alkylene)-N^{⊕}R₄₁R₄₂R₄₃; —N(R₄₀)—(C₁-C₄alkylene)-NR₄₁R₄₂; —N[(C₁-C₄alkylene)-NR₄₁R₄₂]₂; —N(R₄₀)—(C₁-C₄alkylene)-N^{⊕}R₄₁R₄₂R₄₃; —N[(C₁-C₄alkylene)-N^{⊕}R₄₁R₄₂R₄₃]₂; —N(R₄₀)—NR₄₁R₄₂; or —N(R₄₀)—N^{⊕}R₄₁R₄₂R₄₃,
wherein R₄₁, R₄₂ and R₄₃ are each independently of the others hydrogen; unsubstituted or substituted C₁-C₄alkyl or unsubstituted or substituted aryl; or
wherein R₄₁ and R₄₂, together with the nitrogen atom linking them, form an unsubstituted or substituted 6-membered ring that may contain further hetero atoms, especially a piperazine ring.

Bleach catalysts of formula (4) to which greater preference is given are 1:1 Me(III) complexes of formula (4′α) 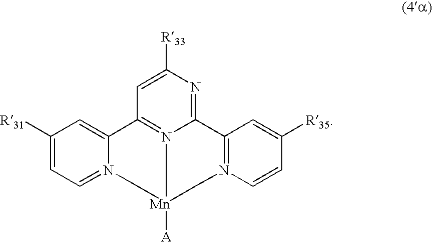
wherein

R′₃₃ is —OH;

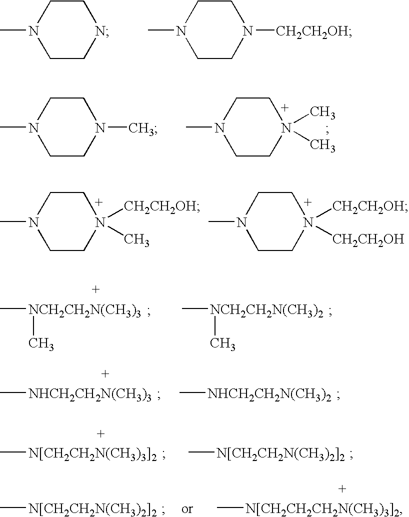

R′₃₁ and R′₃₅ each independently of the other has the meanings given for R′₃₃ or is hydrogen, and

A is F⁻; Cl⁻; Br⁻; I⁻; perchlorate; sulfate; nitrate; OH⁻; BF₄⁻; PF₆⁻ or carboxylate.

A bleach catalyst of formula (4) and (4′α) to which special preference is given is the bleach catalyst of formula (4a):

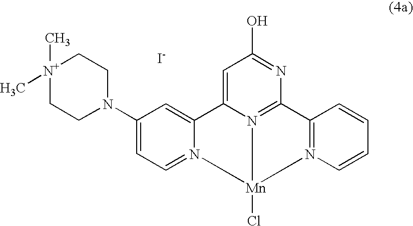

Bleach catalysts of formula (4) to which greater preference is likewise given are 1:1 Me(III) complexes of formula (4′β) 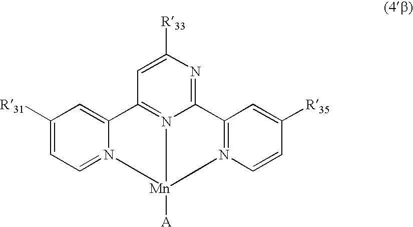
wherein

R′₃₃ is —OH;

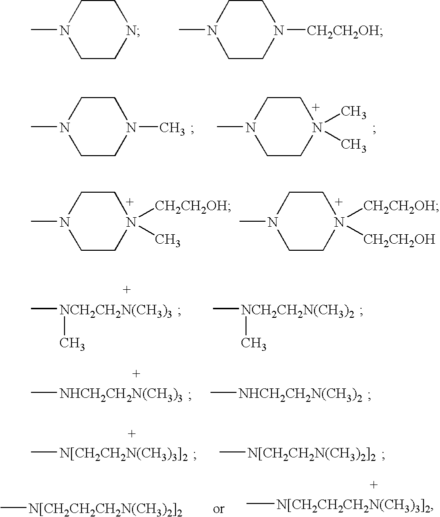

R′₃₁ and R′₃₅ each independently of the other has the meanings given for R′₃₃ or is hydrogen, and

A is F⁻; Cl⁻; Br⁻; I⁻; perchlorate; sulfate; nitrate; OH⁻; BF₄⁻; PF₆⁻ or carboxylate.

The above-mentioned bleach catalysts of formulae (1) to (3) are prepared according to generally known processes.

Compounds of the bispyridyl-pyrimidine type (formula (4), wherein Q=CR₃₈) can be prepared in a manner known per se [F. H. Case etal., J. Org. Chem. 1967, 32(5), 1591-1596]). For that purpose, for example, one part pyridine-2-carboxylic acid ester and one part ethyl acetate can be reacted with sodium hydride, and the intermediate obtained after aqueous work-up, a β-keto ester, can be reacted with 2-amidinopyridine, to yield the corresponding pyrimidine derivatives, which can be converted to the corresponding chlorine compounds by reaction with a chlorinating agent such as, for example, PCl₅/POCl₃.

Reactions of those compounds with amines, as desired in the presence of an excess of redox-active transition metal salts, such as manganese, iron or ruthenium, in order to accelerate substitution, yield amine-substituted bispyridyl-pyrimidines. Preparation processes using the last two mentioned metal anions are described, for example, in J. Chem. Soc., Dalton Trans 1990, 1405-1409 (E. C. Constable et al) and New. J. Chem. 1992, 16, 855-867.

Compounds of the bispyridyl-triazine type (formula (4), wherein Q=N) can be prepared analogously to known processes (e.g. EP-A-555 180 and EP-A-556 156 or F. H. Case et al., J. Am. Chem. Soc. 1959, 81, 905-906) by, for example, reacting two parts 2-cyanopyridine with urea or guanidine and a base.

In the particulate compositions according to the invention, especially in the granules, the bleach catalysts [component (a)] are present in an amount of from 1 to 40% by weight, preferably from 2 to 25% by weight, and especially from 4 to 20% by weight, based on the total weight of the particulate composition.

The alkali metal and/or alkaline earth metal and/or aluminium salts [component (b)] preferably used are carbonates, hydrogen carbonates, phosphates, polyphosphates, tripolyphosphates, sulfates, silicates, sulfites, borates, halides and pyrophosphates. Preferably, alkaline earth metal salts, such as sodium, calcium and magnesium salts, especially sodium sulfate, calcium sulfates, calcium chloride, calcium phosphate, magnesium sulfate or magnesium chloride, are used. Calcium salts are especially preferred.

It is also possible for the salts normally employed in washing compositions to be used.

In the particulate compositions according to the invention, especially in the granules, the alkali metal and/or alkaline earth metal and/or aluminium salts [component (b)] are present in an amount of from 0 to 65% by weight, preferably from 1 to 55% by weight, and especially from 3 to 50% by weight, based on the total weight of the particulate composition.

The binder [component (c)] must be water-soluble and must have sealing (sinterable) properties, that is to say, it must be meltable and/or thermoplastic so that, after the granulation procedure, the pores and capillaries of the granule matrix are sealed as a result. The binder should either have a melting point (m.p.) of from 30 to 120° C., preferably from 35 to 100° C., and especially from 38 to 90° C., or have a glass transition temperature of from 30 to 120° C., preferably from 35 to 100° C., and especially from 38 to 90° C.

Mixtures of polymers of high and low molecular weight are advantageous.

Suitable binders of that kind are especially either water-soluble polymers or water-soluble/water-dispersible non-ionic surfactants of which either the melting point or the glass transition temperature is in the range indicated.

Mixtures of low molecular weight components and high molecular weight components, such as, for example, PEG 8000 with PEG 2000 or PEG 8000 with a polyethylene oxide having a molecular weight of 100 000 are very advantageous in terms of thermoplastic properties.

In general, the following are preferred: polyethylene glycols having a molecular weight of from 2000 to 20000, polyethylene oxides having a molecular weight of from 100 000 to 1 000 000; copolymers of ethylene oxide and propylene oxides having a molecular weight of >3 500; copolymers of vinylpyrrolidone with vinyl acetate; polyvinylpyrrolidones having a molecular weight of <20 000; copolymers of ethyl acrylate and methacrylate and methacrylic acid (ammonium salt); hydroxypropyl methylcellulose phthalate; polyvinyl alcohol, and also hydroxypropyl methylcellulose. In the form of melts, such mixtures are of low viscosity and are advantageously able to be processed.

By suitable selection of the appropriate polymer/surfactant or surfactant/surfactant combination it is thus possible, in addition to influencing the storage stability (resistance to deactivation), also to influence significantly the dissolution properties of the particulate compositions according to the invention in use (washing liquor).

The following may be mentioned as examples of binders that, during the granulation process, either are melted or are dissolved in water:

1. fatty alcohols having from 8 to 22 carbon atoms, especially cetyl alcohol;

2. addition products of, preferably, from 2 to 80 mol of alkylene oxide, especially ethylene oxide, wherein some of the ethylene oxide units may have been replaced by substituted epoxides, such as styrene oxide and/or propylene oxide, with higher unsaturated or saturated monoalcohols, fatty acids, fatty amines or fatty amides having from 8 to 22 carbon atoms or with benzyl alcohols, phenyl phenols, benzyl phenols or alkyl phenols, the alkyl radicals of which have at least 4 carbon atoms;

3. alkylene oxide, especially propylene oxide, condensation products (block polymers);

4. ethylene oxide/propylene oxide adducts with diamines, especially ethylenediamine;

5. reaction products of a fatty acid having from 8 to 22 carbon atoms and a primary or secondary amine having at least one hydroxy-lower alkyl or lower alkoxy-lower alkyl group, or alkylene oxide addition products of such hydroxyalkyl-group-containing reaction products;

6. sorbitan esters, preferably having long-chain ester groups, or ethoxylated sorbitan esters, such as polyoxyethylene sorbitan monolaurate having from 4 to 10 ethylene oxide units or polyoxyethylene sorbitan trioleate having from 4 to 20 ethylene oxide units;

7. addition products of propylene oxide with a tri- to hexa-hydric aliphatic alcohol having from 3 to 6 carbon atoms, e.g. glycerol or pentaerythritol; and

8. fatty alcohol polyglycol mixed ethers, especially addition products of from 3 to 30 mol of ethylene oxide and from 3 to 30 mol of propylene oxide with aliphatic monoalcohols having from 8 to 22 carbon atoms.

Especially suitable non-ionic dispersing agents are surfactants of formula (5)
R₄₄—O-(alkylene-O)ₙ—R₄₅ (5),
wherein

R₄₄ is C₈-C₂₂alkyl or C₈-C₁₈alkenyl,

R₄₅ is hydrogen; C₁-C₄alkyl; a cycloaliphatic radical having at least 6 carbon atoms; or benzyl,

“alkylene” is an alkylene radical having from 2 to 4 carbon atoms, and

n is a number from 1 to 60.

The substituents R₄₄ and R₄₅ in formula (5) are advantageously the hydrocarbon radical of an unsaturated or, preferably, saturated aliphatic monoalcohol having from 8 to 22 carbon atoms. The hydrocarbon radical may be straight-chain or branched. R₄₄ and R₄₅ are preferably each independently of the other an alkyl radical having from 9 to 14 carbon atoms.

Aliphatic saturated monoalcohols that come into consideration include natural alcohols, e.g. lauryl alcohol, myristyl alcohol, cetyl alcohol or stearyl alcohol, and also synthetic alcohols, e.g. 2-ethylhexanol, 1,1,3,3-tetramethylbutanol, octan-2-ol, isononyl alcohol, trimethyl-hexanol, trimethyinonyl alcohol, decanol, C₉-C₁₁oxo-alcohol, tridecyl alcohol, isotridecyl alcohol and linear primary alcohols (Alfols) having from 8 to 22 carbon atoms. Some examples of such Alfols are Alfol (8-10), Alfol (9-11), Alfol (10-14), Alfol (12-13) and Alfol (16-18). (“Alfol” is a registered trade mark of CONDEA Vista Company). Unsaturated aliphatic monoalcohols are, for example, dodecenyl alcohol, hexadecenyl alcohol and oleyl alcohol.

The alcohol radicals may be present singly or in the form of mixtures of two or more components, e.g. mixtures of alkyl and/or alkenyl groups that are derived from soybean fatty acids, palm kernel fatty acids or tallow oils.

(Alkylene-O) chains are preferably bivalent radicals of formula (CH₂—CH₂—)—,

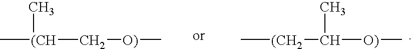

Examples of a cycloaliphatic radical include cycloheptyl, cyclooctyl and preferably cyclohexyl.

As non-ionic dispersing agents there come into consideration preferably surfactants of formula (6) 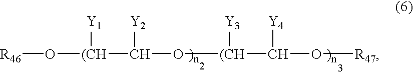
wherein

R₄₆ is C₈-C₂₂alkyl,

R₄₇ is hydrogen or C₁-C₄alkyl,

Y₁, Y₂, Y₃ and Y₄ are each independently of the others hydrogen, methyl or ethyl,

n₂ is a number from 0 to 8, and

n₃ is a number from 2 to 40.

Further important non-ionic dispersing agents correspond to formula (7) 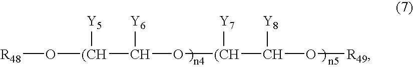
wherein

R₄₈ is C₉-C₁₄alkyl,

R₄₉ is C₁-C₄alkyl,

Y₅, Y₆, Y₇ and Y₈ are each independently of the others hydrogen, methyl or ethyl, one of the radicals Y₅, Y₆ and one of the radicals Y₇, Y₈ always being hydrogen; and

n₄ and n₅ are each independently of the other an integer from 4 to 8.

The non-ionic dispersing agents of formulae (5) to (7) can be used in the form of mixtures. For example, as surfactant mixtures there come into consideration non-end-group-terminated fatty alcohol ethoxylates of formula (5), that is compounds of formula (5) wherein

R₄₄ is C₈-C₂₂alkyl,

R₄₅ is hydrogen and

the alkylene-O chain is the radical —(CH₂—CH₂—O)—;

and also end-group-terminated fatty alcohol ethoxylates of formula (7).

Examples of non-ionic dispersing agents of formulae (5), (6) and (7) include reaction products of a C₁₀-C₁₃fatty alcohol, e.g. a C₁₃oxo-alcohol, with from 3 to 10 mol of ethylene oxide, propylene oxide and/or butylene oxide and the reaction product of one mol of a C₁₃fatty alcohol with 6 mol of ethylene oxide and 1 mol of butylene oxide, it being possible for the addition products each to be end-group-terminated with C₁-C₄alkyl, preferably methyl or butyl.

In the particulate compositions according to the invention, especially in the granules, water-soluble binders having sealing properties [component (c)] are present in an amount of from 5 to 90% by weight, preferably from 7 to 80% by weight, and especially from 7 to 70% by weight, based on the total weight of the particulate composition.

In the particulate compositions according to the invention, especially in the granules, water [component (d)] is present in an amount of from 0.05 to 12% by weight, preferably from 0.1 to 8% by weight, and especially from 0.3 to 10% by weight, based on the total weight of the particulate compositions.

This (residual) water originates from the components (a) and/or (c) used and/or from the optional further components (b), (e) to (k), which may or may not be used, and/or from the granulating or coating process.

The particulate compositions according to the invention may in addition comprise one or more water-soluble polymers and/or dispersing agents [component (e)].

Those polymers and/or dispersing agents, unlike the compounds of component (c), are neither meltable nor thermoplastic in the range up to 150° C.

The anionic dispersing agents preferably used are especially commercially available water-soluble anionic dispersing agents for dyes, pigments etc.

In that respect, the following compounds, especially, may be mentioned: condensation products of aromatic sulfonic acids and formaldehyde; condensation products of aromatic sulfonic acids with unsubstituted or chlorinated diphenyls or diphenyl oxides and optionally formaldehyde; (mono-/di-)alkyinaphthalenesulfonates; sodium salts of polymerised organic sulfonic acids; sodium salts of polymerised alkylnaphthalenesulfonic acids; sodium salts of polymerised alkylbenzenesulfonic acids; alkylarylsulfonates; sodium salts of alkyl polyglycol ether sulfates; polyalkylated polynuclear arylsulfonates; methylene-linked condensation products of arylsulfonic acids and hydroxyarylsulfonic acids; sodium salts of dialkylsulfosuccinic acid; sodium salts of alkyl diglycol ether sulfates; sodium salts of polynaphthalenemethanesulfonates; lignosulfonates or oxylignosulfonates; and heterocyclic polysulfonic acids.

The dispersing agents can be used singly or in the form of a mixture of two or more dispersing agents.

Especially suitable anionic dispersing agents are condensation products of naphthalenesulfonic acids with formaldehyde; sodium salts of polymerised organic sulfonic acids; (mono-/di-)alkylnaphthalenesulfonates; polyalkylated polynuclear arylsulfonates; sodium salts of polymerised alkylbenzenesulfonic acids; lignosulfonates; oxylignosulfonates and condensation products of naphthalenesulfonic acid with a polychloromethyldiphenyl.

As water-soluble polymers that are neither meltable nor thermoplastic, there are preferably used copolymers of acrylic acid with sulfonated styrenes; polyethylenesulfonic acids; sodium carboxymethylcellulose; gelatin; polyacrylates and maltodextrin.

In the particulate compositions according to the invention, especially in the granules, such water-soluble polymers and/or dispersing agents [component (e)] are present in an amount of from 0 to 70% by weight, preferably from 0 to 60% by weight, and especially from 0 to 55% by weight, based on the total weight of the particulate composition.

The particulate compositions according to the invention may in addition comprise one or more fillers [component (f)]. The purpose of the fillers is to adapt the content of the bleach catalyst (or bleach catalysts) to the desired concentration. The filler materials are used in undissolved state.

Suitable fillers may be either organic or inorganic materials.

Preferred organic filler materials [component (f)] are as follows:

1 ) anionic dispersing agents as defined and described above, provided that the dispersing agents are not present in the dissolved state during granulation;

2) polycarboxylates and/or water-soluble polysiloxanes. Of the polycarboxylates, preference is given to the polyhydroxycarboxylates, especially citrates, dextrin, maltodextrin or maize starch;

3) low-molecular-weight organic acids and salts thereof: There come into consideration as low-molecular-weight organic acids, for example, mono- or poly-carboxylic acids. Of special interest are aliphatic carboxylic acids, especially those having a total number of from 1 to 12 carbon atoms. Preferred acids are aliphatic C₁-C₁₂-mono- or -poly-carboxylic acids, the monocarboxylic acids being especially those having at least 3 carbon atoms in total. As substituents of the carboxylic acids there come into consideration, for example, hydroxy and amino, especially hydroxy. Special preference is given to aliphatic C₂-C₁₂polycarboxylic acids, especially aliphatic C₂-C₆polycarboxylic acids. Very special preference is given to hydroxy-substituted aliphatic C₂-C₆poly-carboxylic acids. There may be mentioned as examples especially oxalic acid, tartaric acid, acetic acid, propionic acid, succinic acid, maleic acid, citric acid, formic acid, gluconic acid, p-toluenesulfonic acid, terephthalic acid, benzoic acid, phthalic acid, acrylic acid and polyacrylic acid. These compounds can be used in the form of the free acid and/or in the form of salts, especially alkali metal salts.

Preferred fillers [component (f)] are anionic dispersing agents and/or polycarboxylates. More preferred are anionic dispersing agents and/or polyhydroxycarboxylates. Special preference is given to anionic dispersing agents, citrates and/or maize starch.

Filler materials [component (f)] that are likewise preferred are water-insoluble organic materials, which do not dissolve either during granulation or under the conditions of use. Such filler materials are especially calcium salts of saturated and unsaturated fatty acids, sawdust, paper fibres, activated carbon, natural fibres and natural fabric, cellulose materials, macroporous adsorber resins, crosslinked polyacrylic acid (e.g. polycarbophil, CAS 9003 97-8, Goodrich, Neuss) or highly disperse, solid polymer compounds formed by polymerisation, polycondensation or polyaddition reactions or by a combination of such reactions.

Special preference is given to cellulose materials, microcrystalline cellulose, urea-formaldehyde condensation products and melamine-formaldehyde condensation products.

The carrier material may be, for example, a highly disperse, solid polymer compound, formed by polymerisation, polycondensation or polyaddition reactions or by a combination of such reactions. Such polymer compounds are described, for example, in GB-A-1 323 890 or CH 522 007 and include polycondensation products, especially polycondensed aminoplastics, for example urea-formaldehyde and melamine-formaldehyde polymer compounds and also vinyl polymers, for example polyacrylonitrile.

The water-insoluble urea-formaldehyde polymer compounds and the preparation of those polymers are known, for example, from A. Renner: Makromolekulare Chemie 149, 1-27 (1971).

The urea-formaldehyde polymer compounds are prepared by reacting formaldehyde with urea in aqueous solution. The reaction is preferably carried out in two steps. In the first reaction step, urea is reacted with formaldehyde according to a customary condensation mechanism, yielding a low-molecular-weight, water-soluble precondensate. In the second reaction step, an acid catalyst may be used for the purpose of accelerating the reaction and for crosslinking, there being formed an insoluble, finely divided solid.

Preferred fillers [component (f)] of that kind are calcium salts of saturated and unsaturated fatty acids, cellulose materials and also melamine-formaldehyde condensation products.

Filler materials [component (f)] to which preference is likewise given are aluminium oxide, magnesium oxide and silicates. There are especially suitable sodium salts of crystalline layered silicates of the formula NaHSiₜO₂ₜ₊₁.pH₂O or Na₂SiₜO₂ₜ₊₁.pH₂O wherein t is a number from 1.9 to 4 and p is a number from 0 to 20. Among the aluminum silicates, preference is given to those commercially available under the names zeolite A, B, X and HS, and also to mixtures comprising two or more such components.

Filler materials [component (f)] of that kind to which special preference is given are layered silicates and magnesium oxide.

In the particulate compositions according to the invention, especially in the granules, such filler materials [component (f)] are present in an amount of from 0 to 90% by weight, preferably from 0 to 80% by weight, and especially from 0 to 70% by weight, based on the total weight of the particulate composition.

The particulate compositions according to the invention may in addition comprise one or more plasticizers [component (g)]. The plasticizers serve to adjust the glass transition temperature of the particular binder [component (c)] to the required temperature range.

Suitable plasticizers include especially long-chained alcohols, polyethylene glycols (preferably having a maximum molecular weight of 600), glycerol, triethylene glycol, polypropylene glycol, butanediol, diethyl phthalate, triacetin and/or polyethylene glycol 3350.

In the particulate compositions according to the invention, especially in the granules, such plasticizers [component (g)] are present in an amount of from 0 to 8% by weight, preferably from 0 to 6% by weight, and especially from 0 to 4% by weight, based on the total weight of the particulate composition.

The particulate composition according to the invention may in addition comprise one or more white pigments [component (h)]. The white pigments serve to inhibit or mask any undesired inherent colour of a formulation component.

Suitable white pigments are especially titanium dioxide, talc, SiO₂, calcium carbonate and barium sulfate, special preference being given to titanium dioxide having an average particle size (X₅₀) of <1.5 μm.

In the particulate compositions according to the invention, especially in the granules, such white pigments [component (h)] are present in an amount of from 0 to 50% by weight, preferably from 0 to 40% by weight, and especially from 0 to 25% by weight, based on the total weight of the particulate composition.

The particulate compositions according to the invention may in addition comprise one or more water-soluble or water-dispersible dyes/pigments [component (i)]. Such dyes/pigments are for the purpose of colouring the granules. Only bleach-resistant dyes and pigments come into consideration.

Preferably, water-insoluble bleach-resistant organic pigments of the colours blue, green and yellow are used.

Such pigments are preferably used in combination with one (or more) of the above-mentioned white pigments [component (h)].

In the particulate compositions according to the invention, especially in the granules, such water-soluble or water-dispersible dyes/pigments [component (i)] are present in an amount of from 0 to 5% by weight, preferably from 0 to 4% by weight, and especially from 0 to 2% by weight, based on the total weight of the particulate composition.

The particulate compositions according to the invention may in addition comprise one or more anti-adherents and/or lubricants [component (f)]. Such anti-adherents and/or lubricants serve to inhibit any adhesion of the granular mass to the surface of the granulation plant (especially during melting) and to reduce friction during the granulating process.

Suitable anti-adherents and/or lubricants are especially magnesium stearate, calcium stearate, aluminium stearate, talc, silicones and lecithin.

In the particulate compositions according to the invention, especially in the granules, such anti-adherents and/or lubricants [component (j)] are present in an amount of from 0 to 5% by weight, preferably from 0 to 4% by weight, and especially from 0 to 2% by weight, based on the total weight of the particulate composition.

The particulate compositions according to the invention may in addition comprise one or more additives [component (k)].

Suitable additives are especially optical brighteners; suspending agents for dirt; pH regulators; foam regulators; salts for regulating the spray-drying and the granulating properties; fragrances; preservatives; wetting agents; dissolution accelerators; disintegrants, such as powdered or fibrous cellulose; antistatic agents; fabric conditioners; enzymes; toning agents; non-ionic surfactants; and polymers which, during the washing of textiles, prevent staining caused by dyes in the washing liquor which have been released from the textiles under the washing conditions.

Suitable wetting agents are especially anionic surfactants, for example a sulfate, sulfonate or carboxylate surfactant or a mixture of such surfactants. Preferred sulfates are those having from 12 to 22 carbon atoms in the alkyl radical or alkyl ethoxysulfates in which the alkyl radical contains from 10 to 20 carbon atoms and in which the head group contains on average 2 or 3 ethoxy units. Preferred sulfonates are, for example, alkyl benzenesulfonates having from 9 to 15 carbon atoms in the alkyl radical and/or alkyl naphthaienesulfonates having from 6 to 16 carbon atoms in the alkyl radical in question. The cation in the anionic surfactants is preferably an alkali metal cation, especially sodium.

Preferred carboxylates are alkali metal sarcosinates of formula
R₅₀—CO—N(R₅₁)—CH₂COOM₁,
wherein

R₅₀ is alkyl or alkenyl having from 8 to 18 carbon atoms in the alkyl or alkenyl radical,

R₅₁ is C₁-C₄alkyl; and
M₁ is an alkali metal.

In the particulate compositions according to the invention, especially in the granules, such additives [component (k)] are present in an amount of from 0 to 20% by weight, preferably from 0 to 15% by weight, and especially from 0 to 10% by weight, based on the total weight of the particulate composition.

The particulate compositions according to the invention may optionally be provided with a layer (coating). The layer preferably consists of at least one water-soluble polymer that has a melting point >55° C. and/or has film-forming properties.

As coating compositions there are used especially polyethylene glycols (having a molecular weight of from 6000 to 100 000); sodium carboxymethyl cellulose; carboxymethyl cellulose; methylcellulose; hydroxypropyl methylcellulose; hydroxyethyl cellulose; hydroxypropyl cellulose; ethylcellulose; methyl hydroxyethyl cellulose; methyl hydroxypropyl cellulose; hydrophobically modified hydroxypropyl methylcellulose; gelatin; polyvinyl alcohol; copolymers of ethyl acrylate with methyl acrylate and methacrylic acid (ammonium salt); fatty acids; paraffin; waxes; mono-, di- and tri-glycerides of single or mixed fatty acids; polyvinyl acetates and/or polymers having pH-dependent solubility.

The last-mentioned pH-sensitive polymers for pH-dependent protection and dissolution behaviour are provided especially for applying a pH-sensitive protective layer to the particulate compositions according to the invention so that the active ingredient is released only in the basic environment of a washing liquor. Such polymers are especially hydroxypropyl methylcellulose acetate succinates; hydroxypropyl methylcellulose phthalates; carboxymethyl ethylcellulose; polymethacrylates; cellulose acetate phthalates and aminoalkyl methacrylate copolymers.

The layer with which the particulate compositions according to the invention may optionally be coated is from 0 to 35% by weight, preferably from 0 to 20% by weight, and especially from 0 to 15% by weight, based on the total weight of the particulate composition. The coating composition may itself have a white pigment added to it. The white pigment serves to inhibit or mask any undesired inherent colour of the particulate compositions. The white pigments already mentioned above (=component (h)), especially, are used.

The proportion of white pigments in the coating composition is especially from 0 to 75% by weight, preferably from 0 to 70% by weight, and especially from 0 to 65% by weight, based on the total weight of the coating composition.

When a white pigment is added to the coating composition, one or more coloured pigments as defined above may be used in addition. The proportion of coloured pigment is especially from 0 to 35% by weight, preferably from 0 to 25% by weight, and more especially from 0 to 20% by weight, based on the total weight of white pigment in the coating composition.

The present invention relates preferably to particulate compositions (Z) containing

(a) from 4 to 20% by weight, based on the total weight of the particulate composition, of at least one finely particulate bleach catalyst of formula (1), (1′) (2), (2′), (3), (3′), (4), (4′α) and/or (4′β) having an average particle size (X₅₀) of <35 μm;

(b) from 3 to 50% by weight, based on the total weight of the particulate composition, of at least one sodium, calcium and/or magnesium carbonate; hydrogen carbonate; phosphate; polyphosphate; tripolyphosphate; sulfate; silicate; sulfite; borate; halide and/or pyrophosphate;

(c) from 7 to 70% by weight, based on the total weight of the particulate composition, of at least one water-soluble binder having sealing properties and a melting point of from 38 to 90° C.;

(d) from 0.3 to 10% by weight, based on the total weight of the particulate composition, water;

(e) from 0 to 55% by weight, based on the total weight of the particulate composition, of at least one water-soluble polymer and/or dispersing agent that is neither meltable nor thermoplastic in the range up to 150° C.;

(f) from 0 to 70% by weight, based on the total weight of the particulate composition, of at least one filler from the group of the polycarboxylates; water-soluble polysiloxanes; aliphatic C₂-C₁₂polycarboxylic acids; calcium salts of saturated and unsaturated fatty acids; sawdust; paper fibres; activated carbon; natural fibres and natural fabric; cellulose materials; macroporous adsorber resins; crosslinked polyacrylic acid; highly disperse, solid polymer compounds formed by polymerisation, polycondensation or polyaddition reactions or by a combination of such reactions; aluminium oxide; magnesium oxide; and/or (layered) silicates;

(g) from 0 to 4% by weight, based on the total weight of the particulate composition, of at least one plasticizer from the group of the long-chained alcohols; polyethylene glycols (preferably having a maximum molecular weight of 600); glycerol; triethylene glycol; polypropylene glycol; butanediol; diethyl phthalate; triacetin and/or polyethylene glycol 3350;

(h) from 0 to 25% by weight, based on the total weight of the particulate composition, of at least one white pigment from the group consisting of titanium dioxide; talc; SiO₂; calcium carbonate and/or barium sulfate;

(i) from 0 to 5% by weight, based on the total weight of the particulate composition, of at least one water-soluble or water-dispersible bleach-resistant dye/pigment of the colour blue, green and/or yellow;

(j) from 0 to 2% by weight, based on the total weight of the particulate composition, of at least one anti-adherent and/or lubricant from the group magnesium stearate, calcium stearate and aluminium stearate; talc; silicones and/or lecithin;

(k) from 0 to 20% by weight, based on the total weight of the particulate composition, of at least one further additive selected from optical brighteners; suspending agents for dirt; pH regulators; foam regulators; salts for regulating the spray drying and the granulating properties; fragrances; preservatives; wenting agents; dissolution accelerators; disintegrants, such as powdered or fibrous cellulose; antistatic agents; fabric conditioners; enzymes; toning agents; non-ionic surfactants; and polymers which, during the washing of textiles, prevent staining caused by dyes in the washing liquor which have been released from the textiles under the washing conditions.

The present invention relates more especially to particulate compositions (Z₁) containing

(a) from 4 to 20% by weight, based on the total weight of the particulate composition, of at least one finely particulate bleach catalyst of formula (1), (1′) (2), (2′), (3), (3′), (4), (4′α) and/or (4′β) having an average particle size (X₅₀) of <35 μm;

(b) from 3 to 50% by weight, based on the total weight of the particulate composition, of at least one sodium, calcium and/or magnesium-carbonate; hydrogen carbonate; phosphate; polyphosphate; tripolyphosphate; sulfate; silicate; sulfite; borate; halide and/or pyrophosphate;

(c) from 7 to 70% by weight, based on the total weight of the particulate composition, of at least one water-soluble binder having sealing properties and a melting point of from 38 to 90° C.;

(d) from 0.3 to 10% by weight, based on the total weight of the particulate composition, water;

(e) from 0 to 55% by weight, based on the total weight of the particulate composition, of at least one water-soluble polymer that is neither meltable nor thermoplastic in the range up to 150° C. from the group of the copolymers of acrylic acid with sulfonated styrenes; polyethylenesulfonic acids; sodium carboxymethyl cellulose; gelatin; polyacrylates and maltodextrin, and/or at least one dispersing agent that is neither meltable nor thermoplastic in the range up to 150° C. from the group of the condensation products of naphthalenesulfonic acids with formaldehyde; sodium salts of polymerised organic sulfonic acids; (mono-/di-)alkylnaphthalenesulfonates; polyalkylated polynuclear arylsulfonates; sodium salts of polymerised alkylbenzenesulfonic acids; lignosulfonates; oxylignosulfonates and condensation products of naphthalenesulfonic acid with a polychloromethyldiphenyl;

(f) from 0 to 70% by weight, based on the total weight of the particulate composition, of at least one filler from the group of the citrates; maize starch; oxalic acid; tartaric acid; acetic acid; propionic acid; succinic acid; maleic acid; citric acid; formic acid; gluconic acid, p-toluenesulfonic acid; terephthalic acid; benzoic acid; phthalic acid; acrylic acid; polyacrylic acid; calcium salts of saturated and unsaturated fatty acids; sawdust; paper fibres; activated carbon; natural fibres and natural fabric; cellulose materials; macroporous adsorber resins; crosslinked polyacrylic acid; highly disperse, solid polymer compounds formed by polymerisation, polycondensation or polyaddition reactions or by a combination of such reactions; aluminium oxide; magnesium oxide; and/or (layered) silicates;

(g) from 0 to 4% by weight, based on the total weight of the particulate composition, of at least one plasticizer from the group of long-chained alcohols; polyethylene glycols having a maximum molecular weight of 600; glycerol; triethylene glycol; polypropylene glycol; butanediol; diethyl phthalate; triacetin and/or polyethylene glycol 3350;

(h) from 0 to 25% by weight, based on the total weight of the particulate composition, of at least one white pigment from the group consisting of titanium dioxide having an average particle size (X₅₀) <1.5 μm; talc; SiO₂; calcium carbonate and/or barium sulfate;

(i) from 0 to 5% by weight, based on the total weight of the particulate composition, of at least one water-soluble or water-dispersible bleach-resistant dye/pigment of the colour blue, green and/or yellow;

(j) from 0 to 2% by weight, based on the total weight of the particulate composition, of at least one anti-adherent and/or lubricant from the group magnesium stearate, calcium stearate and aluminium stearate; talc; silicones and/or lecithin;

(k) from 0 to 20% by weight, based on the total weight of the particulate composition, of at least one further additive selected from optical brighteners; suspending agents for dirt; pH regulators; foam regulators; salts for regulating the spray drying and the granulating properties; fragrances; preservatives; wetting agents; dissolution accelerators; disintegrants, such as powdered or fibrous cellulose; antistatic agents; fabric conditioners; enzymes; toning agents; non-ionic surfactants; and polymers which, during the washing of textiles, prevent staining caused by dyes in the washing liquor which have been released from the textiles under the washing conditions.

The present invention relates to particulate compositions (Z₂) containing

(a) from 4 to 20% by weight, based on the total weight of the particulate composition, of at least one finely particulate bleach catalyst of formula (1′), (2′), (3′), (4′α) and/or (4′β) having an average particle size (X₅₀) of <20 μm;

(b) from 3 to 50% by weight, based on the total weight of the particulate composition, of at least one sodium carbonate, calcium carbonate and/or magnesium carbonate; hydrogen carbonate; sulfate and/or sulfite;

(c) from 7 to 70% by weight, based on the total weight of the particulate composition, of at least one water-soluble binder having sealing properties and a melting point of from 38 to 90° C. from the group of polyethylene glycols having a molecular weight of from 2000 to 20 000; polyethylene oxides having a molecular weight of from 100 000 to 1 000 000; copolymers of ethylene oxide and propylene oxides having a molecular weight of >3 500; copolymers of vinylpyrrolidone with vinyl acetate; polyvinylpyrrolidones having a molecular weight of <20 000; copolymers of ethyl acrylate and methacrylate and methacrylic acid (ammonium salt); hydroxypropyl methylcellulose phthalate; polyvinyl alcohol and/or hydroxypropyl methylcellulose;

(d) from 0.3 to 10% by weight, based on the total weight of the particulate composition, water;

(e) from 0 to 55% by weight, based on the total weight of the particulate composition, of at least one water-soluble polymer that is neither meltable nor thermoplastic in the range up to 150° C. from the group of the copolymers of acrylic acid with sulfonated styrenes; polyethylenesulfonic acids; sodium carboxymethyl cellulose; gelatin; polyacrylates and maltodextrin, and/or of at least one dispersing agent that is neither meltable nor thermoplastic in the range up to 150° C. from the group of the condensation products of naphthalenesulfonic acids with formaldehyde; sodium salts of polymerised organic sulfonic acids; (mono-/di-)alkylnaphthalenesulfonates; polyalkylated polynuclear arylsulfonates; sodium salts of polymerised alkylbenzenesulfonic acids; lignosulfonates; oxylignosulfonates and condensation products of naphthalenesulfonic acid with a polychloromethyldiphenyl.

(f) from 20 to 60% by weight, based on the total weight of the particulate composition, of at least one filler from the group of the citrates; maize starch; natural fibres and natural fabric and/or cellulose materials; highly disperse, solid polymer compounds formed by polymerisation, polycondensation or polyaddition reactions or by a combination of such reactions; and/or (layered) silicates;

(g) from 0 to 4% by weight, based on the total weight of the particulate composition, of at least one plasticizer from the group of long-chained alcohols; polyethylene glycols having a maximum molecular weight of 600; glycerol; triethylene glycol; polypropylene glycol; butanediol; diethyl phthalate; triacetin and/or polyethylene glycol 3350;

(h) from 0 to 25% by weight, based on the total weight of the particulate composition, of at least one white pigment from the group titanium dioxide having an average particle size (X₅₀) of <1.5 μm; and/or barium sulfate;

(i) from 0 to 5% by weight, based on the total weight of the particulate composition, of at least one water-soluble or water-dispersible bleach-resistant dye/pigment of the colour blue, green and/or yellow;

(j) from 0 to 2% by weight, based on the total weight of the particulate comrposition, of at least one anti-adherent and/or lubricant from the group magnesium stearate, calcium stearate and aluminium stearate; talc; silicones and/or lecithin;

(k) from 0 to 20% by weight, based on the total weight of the particulate composition, of at least one further additive selected from optical brighteners; suspending agents for dirt; pH regulators; foam regulators; salts for regulating the spray drying and the granulating properties; fragrances; preservatives; wefting agents; dissolution accelerators; disintegrants, such as powdered or fibrous cellulose; antistatic agents; fabric conditioners; enzymes; toning agents; non-ionic surfactants; and polymers which, during the washing of textiles, prevent staining caused by dyes in the washing liquor which have been released from the textiles under the washing conditions.

The present invention relates likewise to particulate compositions (Z₃) containing

(a) from 4 to 20% by weight, based on the total weight of the particulate composition, of at least one finely particulate bleach catalyst of formula (1 a), (2a), (3a) and/or (4a) having an average particle size (X₅₀) of <20 μm;

(b) from 3 to 50% by weight, based on the total weight of the particulate composition, of at least one sodium carbonate, calcium carbonate and/or magnesium carbonate; hydrogen carbonate; sulfate and/or sulfite;

(c) from 7 to 70% by weight, based on the total weight of the particulate composition, of at least one water-soluble binder having sealing properties and a melting point of from 38 to 90° C. from the group of polyethylene glycols having a molecular weight of from 2000 to 20 000; polyethylene oxides having a molecular weight of from 100 000 to 1 000 000; copolymers of ethylene oxide and propylene oxides having a molecular weight of >3 500; copolymers of vinylpyrrolidone with vinyl acetate; polyvinylpyrrolidones having a molecular weight of <20 000; copolymers of ethyl acrylate and methacrylate and methacrylic acid (ammonium salt); hydroxypropyl methylcellulose phthalate; polyvinyl alcohol and/or hydroxypropyl methylcellulose;

(d) from 0.3 to 10% by weight, based on the total weight of the particulate composition, water;

(e) from 0 to 55% by weight, based on the total weight of the particulate composition, of at least one water-soluble polymer that is neither meltable nor thermoplastic in the range up to 150° C. from the group of the copolymers of acrylic acid with sulfonated styrenes; polyethylenesulfonic acids; sodium carboxymethyl cellulose; gelatin; polyacrylates and maltodextrin, and/or of at least one dispersing agent that is neither meltable nor thermoplastic in the range up to 150° C. from the group of the condensation products of naphthalenesulfonic acids with formaldehyde; sodium salts of polymerised organic sulfonic acids; (mono-/di-)alkylnaphthalenesulfonates; polyalkylated polynuclear arylsulfonates; sodium salts of polymerised alkylbenzenesulfonic acids; lignosulfonates; oxylignosulfonates and condensation products of naphthalenesulfonic acid with a polychloromethyldiphenyl.

(f) from 20 to 60% by weight, based on the total weight of the particulate composition, of at least one filler from the group of the citrates; maize starch; natural fibres and natural fabric and/or cellulose materials; highly disperse, solid polymer compounds formed by polymerisation, polycondensation or polyaddition reactions or by a combination of such reactions; and/or (layered) silicates;

(g) from 0 to 4% by weight, based on the total weight of the particulate composition, of at least one plasticizer from the group of long-chained alcohols; polyethylene glycols having a maximum molecular weight of 600; glycerol; triethylene glycol; polypropylene glycol; butanediol; diethyl phthalate; triacetin and/or polyethylene glycol 3350;

(h) from 0 to 25% by weight, based on the total weight of the particulate composition, of at least one white pigment from the group titanium dioxide having an average particle size (X₅₀) of <1.5 μm; and/or barium sulfate;

(i) from 0 to 5% by weight, based on the total weight of the particulate composition, of at least one water-soluble or water-dispersible bleach-resistant dye/pigment of the colour blue, green and/or yellow;

(j) from 0 to 2% by weight, based on the total weight of the particulate composition, of at least one anti-adherent and/or lubricant from the group magnesium stearate, calcium stearate and aluminium stearate; talc; silicones and/or lecithin;

(k) from 0 to 20% by weight, based on the total weight of the particulate composition, of at least one further additive selected from optical brighteners; suspending agents for dirt; pH regulators; foam regulators; salts for regulating the spray drying and the granulating properties; fragrances; preservatives; wetting agents; dissolution accelerators; disintegrants, such as powdered or fibrous cellulose; antistatic agents; fabric conditioners; enzymes; toning agents; non-ionic surfactants; and polymers which, during the washing of textiles, prevent staining caused by dyes in the washing liquor which have been released from the textiles under the washing conditions.

In especially preferred particulate compositions Z, Z₁, Z₂ and Z₃, the average particle size of the bleach catalyst is in the range from 0.01 to 10 μm. More especially, the average particle size is in the range from 0.01 to 2.5 μm. 90% of the bleach catalyst particles generally have a particle size that is <7 μm, preferably <5 μm.

The invention relates also to particulate compositions Z, Z₁, Z₂ and Z₃ that are provided with a layer (coating).

Preferably, such coated particulate compositions consist of up to 35% by weight of coating, especially from 3 to 35% by weight, more especially from 5 to 30% by weight, especially preferably from 5 to 25% by weight of coating, based on the total weight of the coated particulate composition.

The invention accordingly relates also to a coated particulate composition (Ω) consisting of from 65 to 97% by weight of the particulate composition Z, Z₁, Z₂ or Z₃ and from 3 to 35% by weight of a coating consisting of at least one of the following coating compositions: polyethylene glycol (having a molecular weight of from 6000 to 100 000); sodium carboxymethyl cellulose; carboxymethyl cellulose; methylcellulose; hydroxypropyl methylcellulose; hydroxyethyl cellulose; hydroxypropyl cellulose; ethylcellulose; methyl hydroxyethylcellulose; methyl hydroxypropylcellulose; hydrophobically modified hydroxypropyl methylcellulose; gelatin; polyvinyl alcohols; copolymers of ethyl acrylate with methyl acrylate and methacrylic acid; hydroxypropyl methylcellulose acetate succinate; hydroxypropyl methylcellulose phthalate; polymethacrylates; fatty acids; paraffin; waxes; mono-, di- and tri-glycerides of single or mixed fatty acids; cellulose acetate phthalates and aminoalkyl methacrylate copolymers.

The percentages by weight relate in each case to the total weight of the coated particulate composition.

A white pigment can also be added to the coating composition.

The invention accordingly relates also to a coated particulate composition (Ω₁) consisting of from 65 to 97% by weight of the particulate composition Z, Z₁, Z₂ or Z₃ and from 3 to 35% by weight of a coating consisting of at least one of the following coating compositions: polyethylene glycol (having a molecular weight of from 6000 to 8000); sodium carboxymethyl cellulose; carboxymethyl cellulose; methylcellulose; hydroxypropyl methylcellulose; hydroxyethyl cellulose; hydroxypropyl cellulose; ethylcellulose; methyl hydroxyethylcellulose; methyl hydroxypropylcellulose; hydrophobically modified hydroxypropyl methylcellulose; gelatin; polyvinyl alcohols; copolymers of ethyl acrylate with methyl acrylate and methacrylic acid; hydroxypropyl methylcellulose acetate succinate; hydroxypropyl methylcellulose phthalate; polymethacrylates; fatty acids; paraffin; waxes; mono-, di- and tri-glycerides of single or mixed fatty acids; cellulose acetate phthalates and aminoalkyl methacrylate copolymers, the coating containing up to 60% by weight, based on the total weight of the coating composition, of a white pigment and up to 20% by weight, based on the total weight of the coating composition, of a coloured pigment.

The invention relates also to the preparation of the particulate compositions according to the invention, especially granules.

Of major interest in the process is, especially, the grinding of the bleach catalyst or of the mixture of various bleach catalysts. Although the catalyst is already obtained in the finely crystalline state from synthesis, it is only fully active after grinding to the lower μ range. Whether the catalyst is subjected to wet-grinding or to dry-grinding is of no importance.

Irrespective of the nature of the grinding (wet/dry), the catalyst should preferably meet the following minimum requirements in terms of particle distribution: average particle size (X₅₀) of <2.5 μm, preferably in the range from 0.4 to 2.5 μm. 90% (X₉₀) of the particles are <7 μm, preferably <5 μm.

In principle there are suitable for wet grinding any wet grinding mills equipped with grinding bodies (glass, sand or similar) of a size less than 1 mm, preferably from 0.5 to 0.8 mm. The catalyst can be ground, as desired in a circulating or back-and-forth process, until the required particle size is obtained. Preferably, the catalyst is dispersed and ground together with a protective colloid and/or wetting agent. Suitable protective colloids are non-foaming adjuvants which are provided later during the granulating process. Polymers, dispersing agents, and optionally also non-ionic surfactants are preferred. The ratio of catalyst to protective colloid should be in the range from 50:1 to 1:10.

The grinding slurry can be further used in the subsequent granulating process directly or, if necessary can, for example, be dried in vacuo in a chamber or a paddle dryer or heatable kneader and used in the granulation subsequently.

To achieve the desired grinding effect with dry grinding it is necessary to use, for example, mills having a large energy input, such as, for example, a ZM100 laboratory mill (Retsch) or the AFG fluidised-bed opposed-jet mill (Hosokawa-Alpine).

It is more advantageous when the catalyst is cooled before being introduced into the mill, for example using liquid nitrogen, so as to increase its brittleness. It has also proved advantageous to add an adjuvant, such as, for example, alkali metal and/or alkaline earth metal sulfates, to the material being ground, thereby enhancing the grinding effect.

The granules according to the invention can be prepared by various granulation methods. To obtain a stable, closed matrix, the sintering component must, in one step of the granulation process, be melted or at least converted into a plastic state. Methods suitable for that purpose are, in principle, compacting, extrusion, melt extrusion, melt pelleting, granulation in an intensive mixer, fluidised bed granulation and fluid spray dryers.

Generally, forming processes in which the matrix is exposed to high pressure during manufacture so that included gases (air) are able to escape and the matrix formed is as highly compressed as possible are preferred. When a thermally sensitive catalyst is used, methods are employed that do not, or that only briefly, subject the granules to thermal stress. In a preferred procedure, the solid components (including meltable/thermoplastic binder) are mixed together and then

a) melted in the granulator with the action of pressure and/or temperature (melt extrusion, compacting, fluidised bed granulation, melt pelleting);

b) continuously sprayed with water and agglomerated in the granulator (intensive mixer, fluidised bed granulation);

c) mixed together with water and agglomerated in a mixer/kneader and subsequently formed into particles under pressure (extrusion);

d) dissolved/suspended as a whole in water and fed into the granulator for simultaneous drying and agglomeration (fluidised bed granulation, fluid spray dryers),

the desired granules being formed.

Alternatively, in the case of process variant b), a portion of the binder, either in the molten state or in the form of a solution in water, can be sprayed onto the dry mixture in the granulator to initiate granulation.

The prepared granules are, if necessary, made round in a rounder (spheronizer) in order to remove any sharp, friable edges, and then dried (when aqueous methods are used).

It has also been shown that in the case of methods in which the granules are obtained by mechanical stress (crushing), thermal stabilisation leads to a considerable improvement in storage stability. The stabilisation is carried out by heating the granules to a temperature of from 3 to 8° C. above the solidification point of the meltable binder, but in any event at T<T_{S} (T_{S}=melting temperature of the binder). The stabilisation can be carried out equally well in a temperature-controlled chamber or a fluidised bed/fluid bed.

If coating of the granules is desired, there are several methods available. If the coating composition is meltable, then preferably it can be applied to the granules in a mechanical (plowshare) mixer or in a gas flow-generated fluidised bed.

Coating compositions dissolved in water are preferably applied to the granules in a fluidised bed, with water simultaneously being removed to prohibit agglomeration of the granules.

Preferably, the particulate compositions according to the invention are used together with peroxy compounds. Examples that may be mentioned in that regard include the following uses:

a) the bleaching of stains or of soiling on textile material in the context of a washing process;

b) the prevention of redeposition of migrating dyes during the washing of textile material;

c) the cleaning of hard surfaces, especially wall or floor tiles, for example to remove stains that have formed as a result of the action of moulds (“mould stains”);

d) use in washing and cleaning compositions having an antibacterial action;

e) as pretreatment agents for bleaching textiles.

Preference is given to bleaching stains or soiling on textile material, the prevention of redeposition of migrating dyes in the context of a washing process, or the cleaning of hard surfaces, especially wall or floor tiles.

The preferred transition metals in the bleach catalyst of the particulate compositions according to the invention are in that case manganese and/or iron.

The particulate compositions according to the invention are likewise used as catalysts for oxidation reactions with molecular oxygen and/or air.

Methods of preventing the redeposition of migrating dyes in a washing liquor are generally carried out by adding to the washing liquor, which comprises a peroxide-containing washing composition, the amount of particulate composition according to the invention required to give a metal complex concentration of from 0.1 to 200 mg per litre of washing liquor, preferably from 0.1 to 75 mg per litre of washing liquor, especially from 0.1 to 50 mg per litre of washing liquor. Alternatively, a washing composition that already comprises at least one metal complex compound can be added.

The present invention relates furthermore to a combined method of preventing the redeposition of migrating dyes and simultaneously bleaching stains or soiling on textile material. The particulate compositions according to the invention are likewise used for that purpose.

The present invention relates also to a washing, cleaning, disinfecting or bleaching composition containing

I) from 0 to 50% by weight, preferably from 0 to 30% by weight, A) of at least one anionic surfactant and/or B) of at least one non-ionic surfactant,

II) from 0 to 70% by weight, preferably from 0 to 50% by weight, C) of at least one builder substance,

III) from 1 to 99% by weight, preferably from 1 to 50% by weight, D) of at least one peroxide or at least one peroxide-forming substance,

IV) (E) a particulate composition according to the invention Z, Z₁, Z₂, Z₃, Ω and/or Ω₁ in an amount that gives a metal complex concentration in the liquor of from 0.05 to 50 mg/l of liquor, preferably from 0.05 to 30 mg/l of liquor, when from 0.5 to 20 g/l of the washing, cleaning, disinfecting or bleaching composition are added to the liquor, and

V) water to 100% by weight.

The present invention relates furthermore to a peroxide-free and/or “peroxide-forming substance”-free washing, cleaning, disinfecting or bleaching composition containing

I) from 0 to 50% by weight, preferably from 0 to 30% by weight, A) of at least one anionic surfactant and/or B) of at least one non-ionic surfactant,

II) from 0 to 70% by weight, preferably from 0 to 50% by weight, C) of at least one builder substance,

III) (E) a particulate composition according to the invention Z, Z₁, Z₂, Ω or Ω₁ in an amount that gives a metal complex concentration in the liquor of from 0.05 to 100 mg/l of liquor, preferably from 0.05 to 50 mg/l of liquor, when from 0.5 to 20 g/l of the washing, cleaning, disinfecting or bleaching composition are added to the liquor, and

IV) water to 100% by weight.

The above percentages are in each case percentages by weight, based on the total weight of the composition.

When the compositions according to the invention comprise a component A) and/or B), the amount thereof is preferably from 1 to 50% by weight, especially from 1 to 30%, by weight, based on the total weight of the washing composition.

The anionic surfactant A) can be, for example, a sulfate, sulfonate or carboxylate surfactant or a mixture thereof. Preferred sulfates are those having from 12 to 22 carbon atoms in the alkyl radical, optionally in combination with alkylethoxysulfates having from 10 to 20 carbon atoms in the alkyl radical.

Preferred sulfonates are, for example, alkylbenzenesulfonates having from 9 to 15 carbon atoms in the alkyl radical. The cation in the anionic surfactants is preferably an alkali metal cation, especially sodium.

Preferred carboxylates are alkali metal sarcosinates of formula R₅₀—CO—N(R₅₁—CH₂COOM′₁, wherein

R₅₀ is alkyl or alkenyl having from 8 to 18 carbon atoms in the alkyl or alkenyl radical,

R₅₁ is C₁-C₄alkyl and

M′₁ is an alkali metal.

The non-ionic surfactant B) may be, for example, a primary or secondary alcohol ethoxylate, especially a C₈-C₂₀ aliphatic alcohol ethoxylated with an average of from 1 to 20 mol of ethylene oxide per alcohol group.

Preference is given to primary and secondary C₁₀-C₁₅ aliphatic alcohols ethoxylated with an average of from 1 to 10 mol of ethylene oxide per alcohol group.

Non-ethoxylated non-ionic surfactants, for example alkylpolyglycosides, glycerol monoethers and polyhydroxyamides (glucamide), may likewise be used.

When the compositions according to the invention contain a component C), the amount thereof is preferably from 1 to 70% by weight, and especially from 1 to 50% by weight, based on the total weight of the washing composition. Special preference is given to an amount of from 5 to 50% by weight and more especially an amount of from 10 to 50% by weight.

As builder substance C) there come into consideration, for example, alkali metal phosphates, especially tripolyphosphates, carbonates and hydrogen carbonates, especially their sodium salts, silicates, aluminum silicates, polycarboxylates, polycarboxylic acids, organic phosphonates, aminoalkylenepoly(alkylenephosphonate(s)) and mixtures of such compounds.

Silicates that are especially suitable are sodium salts of crystalline layered silicates of the formula NaHSiₜO₂ₜ₊₁.pH₂O or Na₂SiₜO₂ₜ₊₁.pH₂O wherein t is a number from 1.9 to 4 and p is a number from 0 to 20.

Among the aluminum silicates, preference is given to those commercially available under the names zeolite A, B, X and HS, and also to mixtures comprising two or more such components.

Among the polycarboxylates, preference is given to polyhydroxycarboxylates, especially citrates, and acrylates, and also to copolymers thereof with maleic anhydride. Preferred polycarboxylic acids are nitrilotriacetic acid, ethylenediaminetetraacetic acid and ethylenediamine disuccinate either in racemic form or in the enantiomerically pure (S,S) form.

Phosphonates or aminoalkylenepoly(alkylenephosphonate(s)) that are especially suitable are alkali metal salts of 1-hydroxyethane-1,1-diphosphonic acid, nitrilotris(methylenephosphonic acid), ethylenediaminetetramethylenephosphonic acid and diethylenetriaminepentamethylenephosphonic acid.

As peroxide component D) there come into consideration, for example, the organic and inorganic peroxides known in the literature and obtainable commercially that bleach textile materials at conventional washing temperatures, for example at from 10 to 95° C.

The organic peroxides are, for example, mono- or poly-peroxides, especially organic peracids or salts thereof, such as phthalimidoperoxycaproic acid, peroxybenzoic acid, diperoxydodecanoic diacid, diperoxynonanoic diacid, diperoxydecanoic diacid, diperoxyphthalic acid or salts thereof.

Preferably, however, inorganic peroxides are used, for example persulfates, perborates, percarbonates and/or persilicates. It will be understood that mixtures of inorganic and/or organic peroxides can also be used. The peroxides may be in a variety of crystalline forms and have different water contents, and they may also be used together with other inorganic or organic compounds in order to improve their storage stability.

The peroxides are added to the composition preferably by mixing the components, for example using a screw metering system and/or a fluidised bed mixer.

The compositions may comprise, in addition to the combination according to the invention, one or more optical brighteners, for example from the classes bis-triazinylamino-stilbenedisulfonic acid, bis-triazolyl-stilbenedisulfonic acid, bis-styryl-biphenyl or bis-benzofuranylbiphenyl, a bis-benzoxalyl derivative, bis-benzimidazolyl derivative or coumarin derivative or a pyrazoline derivative.

The compositions may furthermore comprise dirt-suspending agents, for example sodium carboxymethylcellulose; pH regulators, for example alkali metal or alkaline earth metal silicates; foam regulators, for example soap; salts for adjusting the spray drying and the granulating properties, for example sodium sulfate; fragrances; antistatic agents; fabric conditioners; enzymes, such as amylase, protease, cellulase and lipase; further bleaching agents; pigments; and/or toning agents. These constituents should especially be stable to the bleaching agent employed.

In order to enhance the bleaching action, the compositions may, in addition to comprising the catalysts described herein, also comprise photocatalysts the action of which is based on the generation of singlet oxygen.

In addition to the particulate compositions according to the invention, further transition metal salts or complexes known as bleach-activating active ingredients and/or conventional bleach activators, that is to say, compounds that under perhydrolysis conditions yield unsubstituted or substituted perbenzoic and/or peroxocarboxylic acids having from 1 to 10 carbon atoms, especially from 2 to 4 carbon atoms, may be used. The customary bleach activators mentioned at the outset that have O- and/or N-acyl groups with the mentioned number of carbon atoms and/or unsubstituted or substituted benzoyl groups are suitable. Preference is given to polyacylated alkylenediamines, especially tetraacetylethylenediamine (TAED), acylated glycolurils, especially tetraacetylglycoluril (TAGU), N,N-diacetyl-N,N-dimethylurea (DDU), acylated triazine derivatives, especially 1,5-diacetyl-2,4-dioxohexahydro-1,3,5-triazine (DADHT), compounds of formula (8): 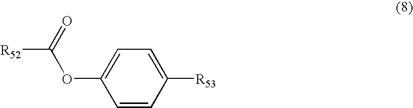
wherein

R₅₂ is a sulfonate group, a carboxylic acid group or a carboxylate group and

R₅₃ is linear or branched C₇-C₁₅alkyl.

Special activators are known under the names SNOBS, SLOBS and DOBA, acylated polyhydric alcohols, especially triacetin, ethylene glycol diacetate and 2,5-diacetoxy-2,5-dihydrofuran and also acetylated sorbitol and mannitol and acylated sugar derivatives, especially pentaacetylglucose (PAG), sucrose polyacetate (SUPA), pentaacetylfructose, tetraacetylxylose and octaacetyllactose as well as acetylated, optionally N-alkylated glucamine and gluconolactone. Combinations of conventional bleach activators, known from German Patent Application DE-A44 43 177 can also be used.

There also come into consideration, as bleach activators, nitrile compounds that form periminic acids with peroxides.

Further preferred additives to the compositions according to the invention are polymers which, during the washing of textiles, prevent staining caused by dyes in the washing liquor that have been released from the textiles under the washing conditions.

Such polymers are preferably polyvinylpyrrolidones, polyvinylimidazoles, copolymers of vinylpyrrolidones and vinylimidazoles, polybetaines or polyvinylpyridine N-oxides, which may have been modified by the incorporation of anionic or cationic substituents, especially those having a molecular weight in the range of from 5000 to 60 000, more especially from 10 000 to 50 000. Such polymers are preferably used in an amount of from 0.05 to 5% by weight, especially from 0.02 to 1.7% by weight, based on the total weight of the washing composition.

Furthermore, the washing composition may optionally also comprise enzymes. Enzymes can be added for the purpose of stain removal. The enzymes usually improve the action on stains caused by protein or starch, such as, for example, blood, milk, grass or fruit juices. Preferred enzymes are cellulases and proteases, especially proteases. Cellulases are enzymes that react with cellulose and its derivatives and hydrolyse them to form glucose, cellobiose and cellooligosaccharides. Cellulases remove dirt and, in addition, have the effect of enhancing the soft handle of the fabric.

Examples of customary enzymes include, but are by no means limited to, the following:

proteases as described in U.S. Pat. No. 6,242,405, column 14, lines 21 to 32;

lipases as described in U.S. Pat. No. 6,242,405, column 14, lines 33 to 46;

amylases as described in U.S. pat. No. 6,242,405, column 14, lines 47 to 56; and

cellulases as described in U.S. Pat. No. 6,242,405, column 14, lines 57 to 64.

The enzymes, when used, may be present in a total amount of from 0.01 to 5% by weight, especially from 0.05 to 5% by weight and more especially from 0.1 to 4% by weight, based on the total weight of the washing composition formulation.

The present invention relates furthermore to a preferred washing, cleaning, disinfecting or bleaching composition containing

I) from 1 to 30% by weight A) of at least one anionic surfactant from the group of the sulfate surfactants having from 12 to 22 carbon atoms in the alkyl radical, optionally in combination with alkylethoxysulfates containing from 10 to 20 carbon atoms in the alkyl radical, and/or of the alkylbenzenesulfonates having from 9 to 15 carbon atoms in the alkyl radical and/or of the alkali metal sarcosinates of formula R₅₀—CO—N(R₅₁)—CH₂COOM′₁, wherein

R₅₀ is alkyl or alkenyl having from 8 to 18 carbon atoms in the alkyl or alkenyl radical,

R₅, is C₁-C₄alkyl and

M′₁ is an alkali metal

and/or of at least one non-ionic surfactant from the group of the condensation products of from 3 to 8 mol of ethylene oxide with 1 mol of primary alcohol containing from 9 to 15 carbon atoms,

II) from 10 to 60% by weight C) of at least one builder from the group of the alkali metal phosphates; carbonates; hydrogen carbonates; silicates; aluminium silicates; polycarboxylates; polycarboxylic acids; organic phosphonates and aminoalkylenepoly(alkylene)phosphonates,

III) from 1 to 99% by weight, preferably from 1 to 50% by weight, D) of at least one peroxide or at least one peroxide-forming substance from the group of the mono- or poly-peroxides; phthalimidoperoxycaproic acid; peroxybenzoic acid; diperoxy-dodecanoic diacid; diperoxynonanoic diacid; diperoxydecanoic diacid; diperoxyphthalic acid or salts thereof; persulfates; perborates; percarbonates and persilicates,

IV) (E) a particulate composition according to the invention Z, Z₁, Z₂, Z₃, Ω and/or Ω₁ in an amount that gives a metal complex concentration in the liquor of from 0.05 to 100 mg/l of liquor, preferably from 0.05 to 50 mg/l of liquor, more preferably from 0.05 to 30 mg/l of liquor when from 0.5 to 20 g/l of the washing, cleaning, disinfecting or bleaching composition are added to the liquor, and

V) water to 100% by weight.

The present invention relates furthermore to a peroxide-free and/or “peroxide-forming substance”-free washing, cleaning, disinfecting or bleaching composition containing

I) from 1 to 30% by weight A) of at least one anionic surfactant from the group of the sulfate surfactants having from 12 to 22 carbon atoms in the alkyl radical, optionally in combination with alkylethoxysulfates containing from 10 to 20 carbon atoms in the alkyl radical, and/or of the alkylbenzenesulfonates having from 9 to 15 carbon atoms in the alkyl radical and/or of the alkali metal sarcosinates of formula R₅₀—CO—N(R₅₁)—CH₂COOM′₁, wherein

R₅₀ is alkyl or alkenyl having from 8 to 18 carbon atoms in the alkyl or alkenyl radical,

R₅₁ is C₁-C₄alkyl and

M′₁ is an alkali metal

and/or of at least one non-ionic surfactant from the group of the condensation products of from 3 to 8 mol of ethylene oxide with 1 mol of primary alcohol containing from 9 to 15 carbon atoms,

II) from 10 to 50% by weight C) of at least one builder from the group of the alkali metal phosphates; carbonates; hydrogen carbonates; silicates; aluminium silicates; polycarboxylates; polycarboxylic acids; organic phosphonates and aminoalkylenepoly(alkylene)phosphonates,

III) (E) a particulate composition according to the invention Z, Zi, Z₂, Z₃, Ω and/or Ω₁ in an amount that gives a metal complex concentration in the liquor of from 0.05 to 100 mg/l of liquor, preferably from 0.05 to 50 mg/l of liquor, more preferably from 0.05 to 30 mg/l of liquor when from 0.5 to 20 g/l of the washing, cleaning, disinfecting or bleaching composition are added to the liquor, and

IV) waterto 100% by weight.

Corresponding washing, cleaning, disinfecting or bleaching processes are usually carried out by using an aqueous liquor containing a peroxide and an amount of the particulate composition according to the invention sufficient to give a metal complex concentration of from 0.05 to 200 mg/l of liquor. The liquor preferably contains from 0.05 to 30 mg of metal complex per litre of liquor.

The formulations according to the invention may also, depending on the composition of the granules according to the invention, be used as such or as additives in other formulations or in combination with another formulation.

Preferably, the formulations according to the invention are used in a washing composition or in a washing composition additive, such as, for example, in a pretreatment and/or aftertreatment composition, in a stain-removing salt, in a washing-power enhancer, in a fabric softener, in a bleaching agent or in a UV-protection enhancer.

The formulations according to the invention are used especially in the form of additives in a washing composition formulation. Such a washing composition formulation may be in solid, liquid, gel-like or paste-like form, for example in the form of a liquid non-aqueous washing composition containing not more than 5% by weight, preferably from 0 to 1% by weight, water and may be based on a suspension of a builder substance in a non-ionic surfactant, for example as described in GB-A-2 158 454.

The formulations according to the invention may also be in the form of powders, (super)compact powders, in the form of single-layer or multi-layer tablets (tabs), in the form of washing composition bars, washing composition blocks, washing composition sheets, washing composition pastes, washing composition gels, or in the form of powders, pastes, gels or liquids that are used in capsules or in pouches (sachets).

Preferably, however, the washing compositions are in the form of non-aqueous formulations, powders, tabs or granules.

The washing compositions can be prepared, for example, by first preparing an initial powder by spray-drying an aqueous suspension comprising all the components listed above except for components D) and E), and then adding the dry components D) and E) and mixing everything together. It is also possible to add component E) to an aqueous suspension containing components A), B) and C), then carry out spray-drying, and subsequently mix component D) with the dry mass.

It is also possible to start with an aqueous suspension that comprises components A) and C) but none or only some of component B). The suspension is spray-dried, and then component E) is mixed with component B) and added, and subsequently component D) is admixed in the dry state.

It is also possible to mix all the components together in the dry state.

The washing composition formulation is especially so formulated that the washing liquor during the aqueous washing phase always has a pH value of approximately from 6.5 to 11, preferably from 7.5 to 11.

The washing operations are usually carried out in a washing machine.

There are various types of washing machine, for example
toploader washing machines having a vertical axis of rotation, which generally use from 45 to 83 litres of water and have a wash cycle of from 10 to 60 minutes at temperature of from 10 to 50° C. Washing machines of that type are encountered especially in the USA.
frontloader washing machines having a horizontal axis of rotation, which generally use from 8 to 15 litres of water and have a wash cycle of from 10 to 60 minutes at temperatures of from 30 to 95° C. Washing machines of that type are encountered especially in Europe.
toploader washing machines having a vertical axis of rotation, which generally have a water capacity of from 26 to 52 litres and a wash cycle of from 8 to 15 minutes at temperatures of from 5 to 25° C. Washing machines of that type are encountered especially in Japan.

The liquor ratio is preferably from 1:4 to 1:40, especially from 1:4 to 1:15, more especially from 1:4 to 1:10, and especially preferably from 1:5 to 1:9.

In addition, the particulate compositions according to the invention surprisingly have a distinctly improved bleach-catalysing action on coloured stains on, for example, wall tiles or floor tiles.

The use of the particulate compositions according to the invention as catalysts for reactions with peroxy compounds in cleaning solutions for hard surfaces, especially for wall tiles or floor tiles, is therefore of particular interest.

In addition, the particulate compositions according to the invention together with peroxy compounds exhibit excellent antibacterial action. The use thereof to destroy bacteria or protect against attack by bacteria is therefore also of interest.

The following Examples serve to illustrate the invention but do not limit the invention thereto. Parts and percentages relate to weight, unless otherwise indicated. In the following Examples, the bleach catalyst of formula (2a)

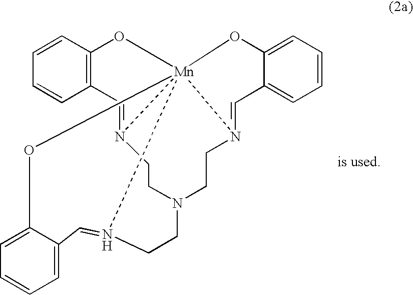

### EXAMPLES

### Grinding of the Catalysts

### Example 1

500 g of a dispersing agent (condensation product of naphthalenesulfonic acid with formaldehyde) are dissolved in 3000 g of deionised water, and then 650 g of catalyst having the structure (2a) are suspended in the solution. The suspension is then subjected to a circulating grinding operation in a Dyno mill. The glass beads used have a diameter of 0.8 mm. With a throughput of 0.2 l/min, the grinding operation is complete after 20 minutes. The particle size is d₅₀=1.45 μm and d₉₀=4.9 μm.

The ground material can be used in the granulating procedure in question either directly or after drying to a residual water content of <5% in a vacuum cabinet or paddle dryer. The dried ground material contains 56.5% by weight of catalyst and 43.5% by weight of dispersing agent.

### Example 2

600 g of catalyst having the structure (2a) are mixed in a tumbler mixer with 600 g of powdered CaSO₄. The mixture is fed together with finely crushed dry ice into a ZM100 laboratory mill (Retsch) where it is ground twice using a 200 μm sieve and in the third pass is ground using an 80 μm sieve. After the third pass, a ground material having a particle size d₅₀=2.3 μm and d₉₀=5.7 μm is obtained.

The ground material is used in the granulation procedure.

### Example 3

1100 g of polyethylene glycol 8000 are dissolved in 4500 g of deionised water and then 600 g of catalyst of formula (2a) are suspended in the solution. The suspension is then subjected to a circulating grinding operation in a Dyno mill. The glass beads used have a diameter of 0.6 mm. With a throughput of 0.2 l/min, the grinding operation is complete after 120 minutes. The particle size is d₅₀=0 75 μm and d₉₀=3.2 μm.

The ground material can be used in the granulating procedure in question either directly or after drying to a residual water content of <5%. The dried ground material contains 35.3% by weight of catalyst and 64.7% by weight of polyethylene glycol 8000.

### Example 4

5000 g of catalyst of formula (2a) are fed continuously into a fluidised-bed opposed-jet mill (100AFG, Hosokawa-Alpine) operated continuously under nitrogen. With a throughput of 2.9 kg/h and a jet pressure of 7 bar, grinding is complete after 100 minutes. The ground material has a particle size of d₅₀=1.3 μm and d₉₀=5.5 μm.

The catalyst ground in that manner is formed into granules after the addition of further formulation components.

### Example 5

350 g of catalyst of formula (2a) are mixed in a tumbler mixer with 700 g of powdered TiO₂ (particle size d₅₀=0.8 μm, d₉₀=2.1 μm ). The mixture is fed together with finely crushed dry ice into a ZM100 laboratory mill (Retsch) where it is ground twice using a 200 μm sieve and in the third pass is ground using an 80 μm sieve. After the third pass, a ground material having a particle size of d₅₀=2.5 μm and X₉₀=6.5 μm is obtained.

The ground material is granulated with admixture of further formulation components.

### Granulation

### Example 6

16.7 g of a mixture consisting of

61.8% by weight cellulose fibres (approximately 300 μm in size),
10.0% by weight Na₂SO₄,
15.2% by weight of a water-soluble, non-ionic surfactant having a melting pqint of 37° C. and
13% by weight of ground catalyst material from Example 2) (compound of formula (2a) together with CaSO₄)
are triturated well for 2 minutes in a porcelain mortar and then additionally homogenised in a laboratory mixer for 30 seconds.

4.0 g of the homogenised mixture are introduced into a hydraulic press (Perkin-Elmer), deaerated by vacuum, and then compressed by a ten-tonne pressure to form 45 mm tablets. The tablets are broken into small fragments manually or using a knife. The fragments are pressed through a 1 mm metal sieve and the resulting fines are removed using a 0.63 mm sieve.

For the purpose of stabilisation, the material having the desired particle size is subject to a temperature of 60° C. for 2 hours in a warming cabinet.

In accordance with the procedure in Example 6, in the following Examples granules with the compositions listed in Table 1 are prepared:

TABLE 1

| | | | Catalyst | Grinding of | |
|---|---|---|---|---|---|
| | | Adjuvant/ | (amount of | the cat. | |
| | Salt and filler | binder | ground material, | according to | Stabilisation |
| Ex. | [% by weight] | [% by weight] | dry) [% by weight] | Ex. | at 60° C. |
| 7 | 60% cellulose fibres | 16% PEG 2000 | 24% | 2) | yes |
| | (c. 300 μm in size) | | | | |
| 8 | 65% cellulose fibres | 19% non-ionic | 16% | 2) | yes |
| | (c. 300 μm in size) | surfactant | | | |
| | | ethoxylated (25 | | | |
| | | EO) linear C₁₆C₁₈ | | | |
| | | fatty alcohol, | | | |
| | | HLB = 15 | | | |
| 9 | 58% cellulose fibres | 24% PEG 2000 | 6% | 4) | yes |
| | (c. 60 μm in size) | | | | |
| | 12% CaSO₄ | | | | |
| 10 | 45% cellulose fibres | 20% non-ionic | 15% | 4) | no |
| | (c. 60 μm in size) | surfactant | | | |
| | 20% Na₂SO₄ | ethoxylated (25 | | | |
| | | EO) linear C₁₆C₁₈ | | | |
| | | fatty alcohol, | | | |
| | | HLB = 15 | | | |
| 11 | 52% dispersing agent | 18% PEG 2000 | 10% | 4) | yes |
| | CC condensation | | | | |
| | product of | | | | |
| | naphthalenesulfonic | | | | |
| | acid with formaldehyde | | | | |
| | 20% CaCO₃ | | | | |
| 12 | 64% condensation | 16% non-ionic | 20% | 2) | yes |
| | product of | surfactant | | | |
| | naphthalenesulfonic | ethoxylated (25 | | | |
| | acid with formaldehyde | EO) linear C₁₆C₁₈ | | | |
| | | fatty alcohol, | | | |
| | | HLB = 15 | | | |
| 13 | 31% cellulose fibres | 22% PEG 8000 | 27% | 5) | no |
| | (c. 300 μm in size) | | | | |
| | 20% CaCO₃ | | | | |
| 14 | 53% cellulose fibres | 5% PEG 8000 | 34% | 3) | yes |
| | (c. 300 μm in size) | | | | |
| | 8% Na₂SO₄ | | | | |
| 15 | 52% cellulose fibres | 19% ethylene | 14% | 2) | no |
| | (c. 300 μm in size) | oxide/ | | | |
| | 15% CaSO₄ | propylene oxide | | | |
| | | block copolymer, | | | |
| | | MW = 4800 | | | |
| 16 | 62% CaCO₃ | 18% PEG 8000 | 20% | 2) | no |
| 17 | 67% CaSO₄ | 10.3% PEG 8000 | 22.7% | 3) | yes |
| 18 | 31% CaSO₄ | 23% PEG 8000 | 26.5% | 1) | yes |
| | 19.5% condensation | | | | |
| | product of | | | | |
| | naphthalenesulfonic | | | | |
| | acid with formaldehyde | | | | |
| 19 | 10% CaSO₄, | 22% PEG 8000 | 10.6% | 1) | yes |
| | 31% CaCO₃ | | | | |
| | 26.4% condensation | | | | |
| | product of | | | | |
| | naphthalenesulfonic | | | | |
| | acid with formaldehyde | | | | |
| 20 | 10% CaSO₄ | 18% PEG 8000 | 17.7% | 1) | yes |
| | 31% cellulose fibres | | | | |
| | (c. 300 μm in size) | | | | |
| | 23.3% condensation | | | | |
| | product of | | | | |
| | naphthalenesulfonic | | | | |
| | acid with formaldehyde | | | | |
| 21 | 15% CaSO₄ | 20% PEG 8000 | 12% | 4) | yes |
| | 31% cellulose fibres | | | | |
| | (c. 300 μm in size) | | | | |
| | 22% CaCO₃ | | | | |
| 22 | 11% CaSO₄ | 19% PEG 8000 | 39% | 5) | yes |
| | 31% cellulose fibres | | | | |
| | (c. 300 μm in size) | | | | |
| 23 | 53% cellulose fibres | 6.7% non-ionic | 28.3% | 3) | yes |
| | (c. 300 μm in size) | surfactant (mixture | | | |
| | 12% CaSO₄ | of glycerol | | | |
| | | monostearate with | | | |
| | | polyoxyethylene | | | |
| | | stearate), HLB = 11 | | | |
| 24 | 59.2% cellulose fibres | 6.0% non-ionic | 19.8% | 3) | no |
| | (c. 300 μm in size) | surfactant (mixture | | | |
| | 15% Na₂SO₄ | of glycerol | | | |
| | | monostearate with | | | |
| | | polyoxyethylene | | | |
| | | stearate), HLB = 11 | | | |
| 25 | 43.1% condensation | 8.3% non-ionic | 39.6% | 3) | yes |
| | product of | surfactant (mixture | | | |
| | naphthalenesulfonic | of glycerol | | | |
| | acid with formaldehyde | monostearate with | | | |
| | 9% CaCO₃ | polyoxyethylene | | | |
| | | stearate), HLB = 11 | | | |
| 26 | 46% cellulose fibres | 7.7% non-ionic | 28.3% | 3) | yes |
| | (c. 300 μm in size) | surfactant | | | |
| | 18% CaSO₄ | ethoxylated (25 | | | |
| | | EO) linear C₁₆C₁₈ | | | |
| | | fatty alcohol, | | | |
| | | HLB = 15 | | | |

### Example 27

1500 g of cellulose fibres (about 300 μm in size), 500 g of PEG 2000 and 500 g of the ground catalyst material from Example 2 are introduced into a plowshare mixer: The components are 5 mixed and homogenised in the mixer for 20 minutes, during which care is taken that the temperature of the material being mixed is always less than 35° C. If necessary, the mixer is cooled.

The mixed material is compressed into large pellets using a roller compacter. The pellets are comminuted in a crushing and sieving machine (Frewitt) using a sieve having a mesh size of 1 mm. The material having the desired particle size (yield about 50%) in the size range from 0.63 to 1.0 mm is separated off using a vibrating sieve. The coarse particles and the fines are fed to the compacter again.

The material having the desired particle size is stabilised in a fluidised bed (STREA1, Aeromatic, Bubendorf, Switzerland) with an air inlet temperature of 50° C. for 30 minutes.

In accordance with the procedure in Example 27, also granules having the compositions listed in Table 2 were prepared:

TABLE 2

| | | | Catalyst | | |
|---|---|---|---|---|---|
| | | Adjuvant/ | (amount of | Grinding | |
| | Salt and filler | binder | ground material, | according to | Stabilisation |
| Ex. | [% by weight] | [% by weight] | dry) [% by weight] | Ex. | at |
| 28 | 12% CaSO₄ | 22% PEG 8000 | 11% | 4) | |
| | 5% CaCO₃ | | | | |
| | 50% condensation | | | | |
| | product of | | | | |
| | naphthalenesulfonic | | | | |
| | acid with | | | | |
| | formaldehyde | | | | |
| 29 | 10% condensation | 14% PEG 8000 | 12% | 4) | 53° C./ |
| | product of | 7% non-ionic | | | 60 min |
| | naphthalenesulfonic | surfactant ethoxylated | | | |
| | acid with | (25 EO) linear C₁₆C₁₈ | | | |
| | formaldehyde | fatty alcohol, HLB = 15 | | | |
| | 20% CaSO₄ | | | | |
| | 37% cellulose | | | | |
| | fibres (c. 300 μm | | | | |
| | in size) | | | | |

### Example 30

1000 g of the granules prepared in Example 28 are introduced into a fluidised bed granulator (STREA1, Aeromatic, Bubendorf, Switzerland). With the introduction of warm air (72° C.), the granules are slowly sprayed with a suspension of TiO₂ in an aqueous solution of polyvinyl alcohol (PVA) (degree of saponification 83%, low-viscosity). In that manner a protective film consisting of polyvinyl alcohol and TiO₂ is built up on the surface of the granules. During the procedure, it is necessary for the supply of PVA solution to be so controlled that granulation is not initiated.

After approximately 90 minutes, 100 g of film (dry weight) have been applied to the granules. The finished granules are white and free-flowing.

### Example 31

439 g of powdered CaSO₄ and 122 g of the ground material from Example 2) (comprising catalyst of structure (2a)) are mixed together in a tumbler mixer. The homogenised mixture is introduced into a fluidised bed granulator (STREA1, Aeromatic, Bubendorf, Switzerland). The pulverulent charge is sprayed with a 30% solution of PEG 8000 in water and granulated in the fluidised bed (inlet air temperature 80° C., outlet air temperature 43° C.). After 90 minutes the granulation is complete. The granules are then stabilised at 58° C. (product temperature) for 30 minutes in the fluidised bed. The particles are discharged from the apparatus and the fraction having the desired particle size of from 0.5 to 1.2 mm is removed by sieving. The finished granules contain 8.8% by weight PEG 8000 as binder.

In accordance with the procedure in Example 31, granules having the compositions listed in Table 3) are prepared:

TABLE 3

| | | | Catalyst | | |
|---|---|---|---|---|---|
| | | Adjuvant/ | (amount of | Grinding of cat. | |
| | Salt and filler | binder | ground material, | according to | Stabilisation |
| Ex. | [% by weight] | [% by weight] | dry) [% by weight] | Ex. | at |
| 32 | 41.1% CaCO₃ | 6.9% PEG 8000 | 12% | 4) | 58° C./ |
| | 40% maltodextrin | | | | 30 min |
| 33 | 36% CaCO₃ | 11% PEG 8000 | 11% | 4) | 58° C./ |
| | 42% CaSO₄ | | | | 30 min |

### Example 34

295 g of powdered CaSO₄, 125 g of powdered PEG 8000 and 50 g of catalyst of structure (2a), which has been ground in accordance with Example 2), are mixed together in a tumbler mixer. The homogenised mixture is introduced into a fluidised bed granulator (STREA1, Aeromatic, Bubendorf, Switzerland) and the powdered material in the fluidised bed is sprayed (inlet air temperature 70° C.) with deionised water in order to begin to dissolve the binder (PEG 8000) and to agglomerate the powder. The granulation is complete after 40 minutes. The fraction having the desired particle size of from 0.5 to 1 2 mm is removed from the granulator outlet by sieving. The finished granules contain 25% by weight PEG 8000 as binder.

### Example 35

The following are dissolved or suspended in succession in 1000 ml of water in a glass beaker:

270 g of condensation product of naphthalenesulfonic acid with formaldehyde, 150 g of CaSO₄ and 150 g of the ground material from Example 3) (catalyst structure (2a)). The mixture is stirred until a homogeneous mixture is obtained. 900 g of the homogeneous slurry are dried in vacuo and then powdered. The dry material is introduced into the fluidised bed granulator as seeds. The slurry, which has not been dried, is diluted to a dry-material content of 30% and is sprayed as binder onto the charge in the fluidised bed. The granulation process is complete after 70 minutes. The granules are discharged and the material having the desired particle size in the range from 0.5 to 1.2 mm is removed by sieving.

### Example 36

3100 g of the ground material from Example 3 having a dry-material content of 27.4%. are brought to a dry-material content of 40% by evaporation in vacuo. The concentrate is mixed in an intensiver mixer with 600 g of CaSO₄ and 1550 g of maize starch to form a homogeneous moist mass. The moist mass is formed into elongate particles using a perforated disc extruder (perforated disc having a diameter of 1 mm). The extrudates are broken up and spheronized in a rounder having a 1 mm perforated disc and then dried in a fluidised bed. The material having the desired particle size (0.63 to 1.2 mm) is removed using a vibrating sieve. The fraction having the desired particle size is 82%. The coarse fraction and fines fraction can be resuspended and extruded again.

### Example 37

600 g of the granules prepared in Example 36 are introduced into a fluidised bed granulator. With the introduction of warm air (75° C.), the granules are slowly heated and sprayed with a suspension of TiO₂ and a green pigment (5% by weight in relation to TiO₂) in an aqueous solution of refined low-viscosity sodium carboxymethyl cellulose. The protective film is built up on the surface of the granules in the course of 75 minutes, and the granules are then dried, yielding slightly green free-flowing granules in which the inherent colour of the catalyst is completely masked.

### Example 38

A mixture of 800 g of ground catalyst of structure 2a) (according to Example 4), 1600 g of TiO₂, 800 g of CaSO₄, 4720 g of PEG 8000 and 80 g of solid green pigment is prepared in a plowshare mixer. The mixture is continuously fed into a 44 mm twin-screw melt extruder. The extruder has 4 temperature zones. In the first two zones, the binder (PEG 8000) is melted at 65° C. and the entire formulation mass is kneaded in the molten state. In the following two zones, in which the temperature is 50° C., solidification of the binder is initiated, so that a presolidified product is pressed through the 1 mm apertures. The product forms stable strands, which cool down rapidly in a cooling bath at room temperature. The through-coloured strands are comminuted in a crushing and sieving machine (Frewitt) using a sieve having a mesh size of 1 mm. The material having the desired particle size (yield about 85%) in the size range from 0.63 to 1.0 mm is separated off using a vibrating sieve. The oversize particles and fines can be returned to the extruder.

### Example 39

The formulation and the procedure are identical to those in Example 38, except that the strands are precooled with cold air at the extruder head and chopped off in the warm state using a rotating blade. After chopping off in the warm state, the granules are cooled to room temperature (25° C.) in an adjacent fluidised bed.

### Example 40

The procedure is as in Example 38), except that the formulation consists of 800 g of ground catalyst of structure (2a) (according to Example 4), 1600 g of TiO₂, 3520 g of CaSO₄, 2000 g of PEG 8000 and 80 g of solid blue pigment.

### Example 41

The formulation used is the same as that in Example 38. In the extruder, all 4 zones are at a temperature of 65° C., so that the product leaves the extruder through a single 6 mm hole in a liquid molten state. The molten product is fed by way of a small buffer container to a pelleting machine (Rotoform, Sandvik) to which a cooling belt is connected.

The rotoform head produces shapes from the melt, on the cooling belt, in the form of through-coloured, hemisperical particles having a diameter of approximately 1 mm, which an be removed very readily from the cooling belt.

### Example 42

The formulation used is the same as that in Example 38; it is fully melted in a glass beaker at 65° C. and then, using a heated pipette, applied manually to a cooling sheet to form small pellets. The pellets are comparable in appearance to those in Example 41.

### Example 42a

960 g of CaCO₃, 200 g of catalyst of structure 2a) (ground material from Example 4) and 440 g of TiO₂ are introduced into a plowshare mixer equipped with a double jacket and a lump breaker and heated at a temperature of 60° C. for 60 minutes. The mixer (including the lump breaker) is then started, and 400 g of premelted (90° C.) PEG 8000 are fed into the mixer in the course of 30 seconds. The granulating process is complete in 5 minutes and the finished granules are discharged into a fluidised bed equipped with a finger stirrer for cooling. The material having the desired particle size in the range from 0.5 to 1.5 mm are removed from the cooled granules by sieving.

### Example 43

Coated granules having the following composition:

| | | Amount |
|---|---|---|
| | Component | (% by weight) |
| Coating | Blue pigment (Vibracolor blue PBL R15-L, | 0.20 |
| | Ciba Specialty Chemicals) | |
| | TiO₂ | 11.57 |
| | Mowiol (polyvinyl alcohol) | 0.87 |
| | PEG 8000 | 3.42 |
| | Metolose SM-4 (methylcellulose) | 3.94 |
| Uncoated | CaSO₄ | 25.69 |
| granules | Maize starch | 20.74 |
| | Arbocel Typ BE00 (cellulose) | 14.40 |
| | PEG 8000 | 8.40 |
| | Compound of formula 2(a), ground to a | 8.38 |
| | particle size of 2 μm | |
| | Water | 2.4 |

### APPLICATION EXAMPLES

### Example 44

### Bleaching Action of a Catalyst Formulation in Washing Compositions

3.0 g of tea-stained cotton fabric (CFT, BC-1) are treated in 300 ml of washing liquor. The liquor contains a base washing composition in a concentration of 2 g/l and sodium percarbonate in a concentration of 3 g/l. The water hardness is 50 ppm CaCO₃. The concentration of catalyst is 15 mg/l (i.e. 150 mg/l of a 10% formulation). The washing operation takes place in a steel beaker in a LINITEST apparatus for 15 minutes at 30° C. The washing operation is carried out a total of 3 times with the same tea stain. To evaluate the bleaching results, the increase in lightness DY of the stain (difference in lightness according to CIE) caused by the treatment is determined spectrophotometrically, in comparison with values without the addition of catalyst; see Table 4.

TABLE 4

| Granules from Example | DY increase |
|---|---|
| Example 7 | 6.4 |
| Example 12 | 6.0 |
| Example 14 | 6.9 |
| Example 22 | 7.3 |
| Example 29 | 8.1 |
| Example 31 | 8.3 |
| Example 36 | 9 |
| Example 39 | 6.5 |
| Example 43 | 8.3 |

The Examples show the appreciable increase in lightness compared with the catalyst-free washing operation (DY=0).

### Example 45

### Storage Stability of a Bleaching Agent Comprising Catalyst Granules

The bleaching agent contains 85.7% sodium percarbonate, 4.7% sodium dodecylsulfate anionic surfactant (Merck, lab) and 4.7% Lutensol AT 50 non-ionic surfactant (BASF, powder) and 4.7% of catalyst granules. In a reference test, 0.5% active catalyst (in this Example of formula 2a), that is not in granular form, is used instead.

20 ml of ammonium sulfate solution (saturated, with sediment) is introduced into a sealable 250 ml glass flask. The bleaching agent is introduced into a 30 ml glass flask. The smaller glass flask is placed in the open state in the larger flask and the larger flask is sealed well.

The sealed flask is stored at 40° C. for 7 or 14 days. The saturated ammonium sulfate solution in the flask causes a relative humidity of 80% in the flask. After storage, the flask is opened and assessed visually. In addition, the content of hydrogen peroxide in the bleaching agent is ascertained iodometrically; see Table 5.

TABLE 5

| | % active oxygen | % active oxygen |
|---|---|---|
| | remaining after | remaining after |
| Granules from Example | storage for 7 days | storage for 14 days |
| 43 | 84 | 51 |
| Reference experiment | 14 | 1 |
| with 0.5% active | | |
| catalyst of formula 2a | | |

The incorporation of the catalyst in a bleaching agent by way of granules according to the invention offers great advantages in terms of stability.

1. A particulate composition containing:
(a) from 1 to 40% by weight, based on the total weight of the particulate composition, of at least one finely particulate bleach catalyst having an average particle size (X₅₀) of <35 μm;
(b) from 0 to 65% by weight, based on the total weight of the particulate composition, of at least one alkali metal salt and/or alkaline earth metal salt and/or aluminium salt;
(c) from 5 to 90% by weight, based on the total weight of the particulate composition, of at least one water-soluble binder having sealing properties;
(d) from 0.05 to 12% by weight, based on the total weight of the particulate composition, water;
(e) from 0 to 70% by weight, based on the total weight of the particulate composition, of at least one water-soluble polymer and/or dispersing agent;
(f) from 0 to 90% by weight, based on the total weight of the particulate composition, of at least one filler;
(g) from 0 to 8% by weight, based on the total weight of the particulate composition, of at least one plasticizer;
(h) from 0 to 50% by weight, based on the total weight of the particulate composition, of at least one white pigment;
(i) from 0 to 5% by weight, based on the total weight of the particulate composition, of at least one water-soluble or water-dispersible dye/pigment;
(j) from 0 to 5% by weight, based on the total weight of the particulate composition, of at least one anti-adherent and/or lubricant;
(k) from 0 to 20% by weight, based on the total weight of the particulate composition, of at least one further additive selected from optical brighteners; suspending agents for dirt; pH regulators; foam regulators; salts for regulating the spray-drying and the granulating properties; fragrances; preservatives; wetting agents; dissolution accelerators; disintegrants; antistatic agents; fabric conditioners; enzymes; toning agents; non-ionic surfactants; and polymers which, during the washing of textiles, prevent staining caused by dyes in the washing liquor which have been released from the textiles under the washing conditions.

2. A particulate composition according to claim 1, wherein the finely particulate bleach catalyst has an average particle size (X₅₀) of from 0.01 to 10 μm.

3. A particulate composition according to claim 1, wherein there is used as component (a) a bleach catalyst of formula (1) 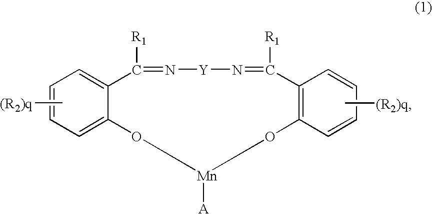
wherein
each R₁, independently of the other, is hydrogen; C₁-C₁₂alkyl unsubstituted or substituted by halogen, C₁-C₄alkoxy, phenyl, carboxyl, C₁-C₄alkoxycarbonyl or mono- or di-C₁-C₄alkylated amino groups; C₄-C₈cycloalkyl unsubstituted or substituted by C₁-C₄alkyl or by C₁-C₄alkoxy; phenyl unsubstituted or substituted by C₁-C₄alkyl, C₁-C₄alkoxy, C₂-C₅alkanoylamino, nitro, sulfo or mono- or di-C₁-C₄alkylated amino groups; or naphthyl unsubstituted or substituted by C₁-C₄alkyl, C₁-C₄alkoxy, C₂-C₅alkanoylamino, nitro, sulfo or mono- or di-C₁-C₄alkylated amino groups;
each R₂, independently of the other(s), is hydrogen; hydroxy; C₁-C₁₂alkyl unsubstituted or substituted by halogen, C₁-C₄alkoxy, phenyl, carboxyl, C₁-C₄alkoxycarbonyl or by a mono- or di-C₁-C₄alkylated amino group; C₁-C₈alkoxy unsubstituted or substituted by halogen, C₁-C₄alkoxy, phenyl, carboxyl, C₁-C₄alkoxycarbonyl or by a mono- or di-C₁-C₄alkylated amino group; halogen; N(C₁-C₄alkyl)₂ or NH(C₁-C₄alkyl) in which at least one alkyl group may be substituted by halogen, C₁-C₄alkoxy, phenyl, carboxyl, C₁-C₄alkoxycarbonyl or by a mono- or di-C₁-C₄alkylated amino group; N^{⊕}(C₁-C₄alkyl)₃ or NH^{⊕}(C₁-C₄alkyl)₂ in which at least one alkyl group may be substituted by halogen, C₁-C₄alkoxy, phenyl, carboxyl, C₁-C₄alkoxycarbonyl or by a mono- or di-C₁-C₄alkylated amino group; or a water-soluble group;
Y is linear or branched alkylene of formula —[C(R₁)₂]ₘ, wherein m is a number from 1 to 8 and each R₁ independently of the other(s), is as defined hereinbefore; —CX═CX—, wherein X is cyano, linear or branched C₁-C₈alkyl or di(linear or branched C₁-C₈alkyl)amino; —(CH₂)ᵣ—NR₁—(CH₂)ᵣ—, wherein R₁ is as defined hereinbefore and r is 1, 2, 3 or 4; or a 1 ,2-cyclohexylene or phenylene group of formula: 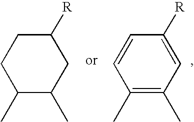
wherein R is hydrogen, CH₂OH, CH₂NH₂ or SO₃M, wherein M is hydrogen, an alkali metal ion, ammonium or a cation that is formed from an amine,
each q, independently of the other, is 0, 1, 2 or 3; and
A is an anion.

4. A particulate composition according to claim 1, wherein there is used as component (a) a bleach catalyst of formula (2) 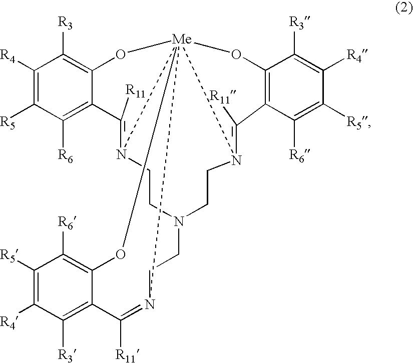
wherein
R₃, R₄, R₅, R₆, R₃′, R₄′, R₅′, R₆′, R₃″, R₄″, R₅″ and R₆″ are each independently of the others hydrogen; cyano; halogen; —SO₃M; —SO₂NH₂; —SO₂NHR₇; —SO₂N(R₇)₂; —OR₇; —COOR₇; nitro; linear or branched C₁-C₈alkyl; linear or branched partially fluorinated or perfluorinated C₁-C₈alkyl; —NHR₈; —NR₈R₉; —N^{⊕}R₈R₉R₁₂ or linear or branched C₁-C₈alkyl-R₁₀;
M is hydrogen; an alkali metal cation; an alkaline earth metal cation; ammonium or an organic ammonium cation;
R₇ is hydrogen; or linear or branched C₁-C₄alkyl;
R₁₀ is OR₇; —COOR₇; —NH₂; —NHR₈; —NR₈R₉ or —N^{⊕}R₈R₉R₁₂;
R₈, R₉ and R₁₂ are the same or different and each is linear or branched C₁-C₁₂alkyl; or R₈ and R₉ together with the nitrogen atom linking them form a 5-, 6- or 7-membered ring that may contain further hetero atoms;
R₁₁, R₁₁′ and R₁₁″ are each independently of the others hydrogen; linear or branched C₁-C₈alkyl or aryl, and
Me is a transition metal.

5. A particulate composition according to claim 1, wherein there is used as component (a) a bleach catalyst of formula (3) 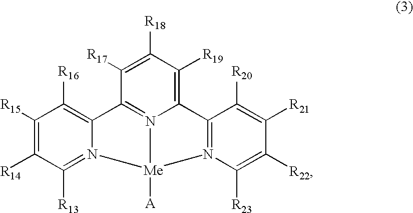
wherein
R₁₃, R₁₄, R₁₅, R₁₆, R₁₇, R₁₈, R₁₉, R₂₀, R₂₁, R₂₂ and R₂₃ are each independently of the others hydrogen; unsubstituted or substituted C₁-C₁₈alkyl; unsubstituted or substituted aryl; cyano; halogen; nitro; —COOR₂₄; —SO₃R₂₄,
wherein R₂₄ is in each case hydrogen; a cation; unsubstituted or substituted C₁-C₁₈alkyl or unsubstituted or substituted aryl;
—SR₂₅; —SO₂R₂₅; —OR₂₅,
wherein R₂₅ is in each case hydrogen; or unsubstituted or substituted C₁-C₁₈alkyl; —NR₂₆R₂₇; —(C₁-C₆alkylene)-NR₂₆R₂₇; —N^{⊕}R₂₆R₂₇R₂₈; —(C₁-C₆alkylene)-N^{⊕}R₂₆R₂₇R₂₈; —N(R₂₅)—(C₁-C₆alkylene)-NR₂₆R₂₇; —N[(C₁-C₆alkylene)-NR₂₆R₂₇]₂; —N(R₂₅)—(C₁-C₆alkylene)-N^{⊕}R₂₆R₂₇R₂₈; —N[(C₁-C₈alkylene)-N^{⊕}R₂₆R₂₇R₂₈]₂; —N(R₂₅)—NR₂₆R₂₇; or —N(R₂₅)—N^{⊕}R₂₆R₂₇R₂₈,
wherein R₂₆, R₂₇ and R₂₈ are each independently of the others hydrogen; unsubstituted or substituted C₁-C₁₈alkyl; or unsubstituted or substituted aryl; or wherein R₂₆ and R₂₇, together with the nitrogen atom linking them, form an unsubstituted or substituted 5-, 6- or 7-membered ring that may contain further hetero atoms,
Me is a transition metal and
A is an anion.

6. A particulate composition according to claim 1, wherein there is used as component (a) a bleach catalyst of formula (4) 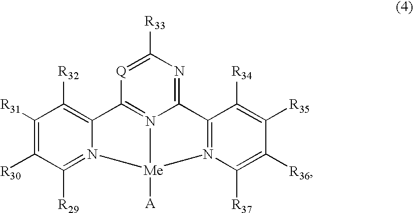
wherein
Q is N or CR₃₈;
R₂₉, R₃₁, R₃₁; R₃₂, R₃₃, R₃₄, R₃₅, R₃₆, R₃₇ and R₃₈ are each independently of the others hydrogen; unsubstituted or substituted C₁-C₁₈alkyl; unsubstituted or substituted aryl; cyano; halogen; nitro; —COOR₃₉; —SO₃R₃₉,
wherein R₃₉ is in each case hydrogen; a cation; unsubstituted or substituted C₁-C₁₈alkyl or unsubstituted or substituted aryl;
—SR₄₀; —SO₂R₄₀; —OR₄₀,
wherein R₄₀ is in each case hydrogen; unsubstituted or substituted C₁-C₁₈alkyl or unsubstituted or substituted aryl; —NR₄₁R₄₂; —(C₁-C₆alkylene)-NR₄₁R₄₂; —N^{⊕}R₄₁R₄₂R₄₃; —(C₁-C₆alkylene)-N^{⊕}R₄₁R₄₂R₄₃; —N(R₄₀)—(C₁-C₆alkylene)-NR₄₁R₄₂; —N[(C₁-C₆alkylene)-NR₄₁R₄₂]₂; —N(R₄₀)—(C₁-C₆alkylene)-NOR₄₁R₄₂R₄₃; —N[(C₁-C₆alkylene)-N^{⊕}R₄₁R₄₂R₄₃]₂; —N(R₄₀)—NR₄₁R₄₂; or —N(R₄₀)—N^{⊕}R₄₁R₄₂R₄₃,
wherein R₄₀ is as defined hereinbefore; and
wherein R₄₁, R₄₂ and R₄₃ are each independently of the others hydrogen; unsubstituted or substituted C₁-C₁₈alkyl or unsubstituted or substituted aryl; or R₄₁ and R₄₂, together with the nitrogen atom linking them, form an unsubstituted or substituted 5-, 6- or 7-membered ring that may contain further hetero atoms;
Me is a transition metal and
A is an anion.

7. A particulate composition according to claim 1, wherein there is used as component (a) a bleach catalyst of formula (1′) 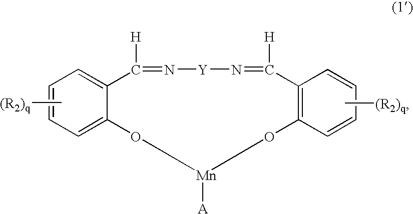
wherein
each R₂, independently of the other(s), is hydroxy; C₁-C₄alkyl unsubstituted or substituted by halogen, C₁-C₄alkoxy, phenyl, carboxyl, C₁-C₄alkoxycarbonyl or by a mono- or di-C₁-C₄alkylated amino group; C₁-C₄alkoxy unsubstituted or substituted by halogen, C₁-C₄alkoxy, phenyl, carboxyl, C₁-C₄alkoxycarbonyl or by a mono- or di-C₁-C₄alkylated amino group; halogen; N(C₁-C₄alkyl)₂ or NH(C₁-C₄alkyl) in which at least one alkyl group may be substituted by halogen, C₁-C₄alkoxy, phenyl, carboxyl, C₁-C₄alkoxycarbonyl or by a mono- or di-C₁-C₄alkylated amino group; or a water-soluble group;
Y is linear or branched alkylene of formula —[C(R₁)2]ₘ, wherein m is a number from 1 to 4 and each R₁, independently of the other(s), is as defined hereinbefore;
—(CH₂)ᵣ—NR₁—(CH₂)ᵣ— wherein R₁ is as defined hereinbefore and r is 1 or 2; or a 1,2-cyclohexylene or phenylene group of formula: 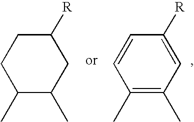
wherein R is hydrogen, CH₂OH, CH₂NH₂ or SO₃M, wherein M is hydrogen, an alkali metal ion, ammonium or a cation that is formed from an amine,
each q, independently of the other, is 0, 1 or 2; and
A is F⁻; Cl⁻; Br⁻; I⁻; perchlorate; sulfate; nitrate; OH⁻; BF₄⁻; PF₆⁻ or carboxylate.

8. A particulate composition according to claim 1, wherein there is used as component (a) a bleach catalyst of formula (2′) 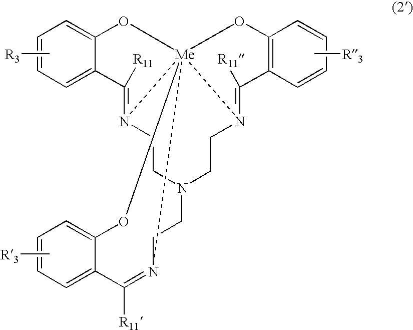
wherein Me is Mn or Fe,
R₃, R₃′ and R₃″ are each independently of the others hydrogen; C₁-C₄alkyl; C₁-C₄alkoxy; hydroxy; nitro; NHR₆; NR₆R₇ or —N^{⊕}R₅R₆R₇, wherein R₅, R₆ and R₇ are each independently of the others C₁-C₄alkyl.

9. A particulate composition according to claim 1, wherein there is used as component (a) a bleach catalyst of formula (3′) 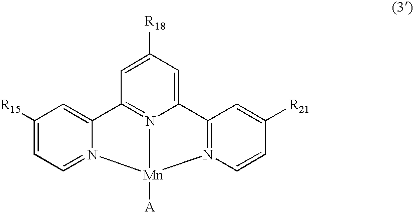
wherein
R₁₈ is C₁-C₄alkoxy; hydroxy; N-mono- or N,N-di-C₁-C₄alkylamino substituted by hydroxy in the alkyl moiety; or an unsubstituted or C₁-C₄alkyl-substituted pyrrolidine, piperidine, piperazine, morpholine or azepane ring, and
R₁₅ and R₂₁ are each independently of the other hydrogen; C₁-C₄alkoxy; hydroxy; N-mono- or N,N-di-C₁-C₄alkylamino substituted by hydroxy in the alkyl moiety; or an unsubstituted or C₁-C₄alkyl-substituted pyrrolidine, piperidine, piperazine, morpholine or azepane ring, and
A is F⁻; Cl⁻; Br⁻; I⁻; perchlorate; sulfate; nitrate; OH⁻; BF₄⁻; PF₆⁻ or carboxylate.

10. A particulate composition according to claim 1, wherein there is used as component (a) a bleach catalyst of formula (4′α) 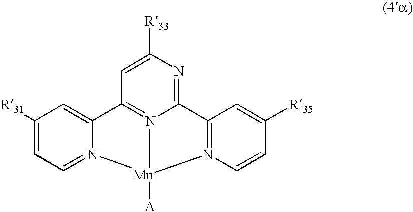
wherein
R′₃₃ is —OH; 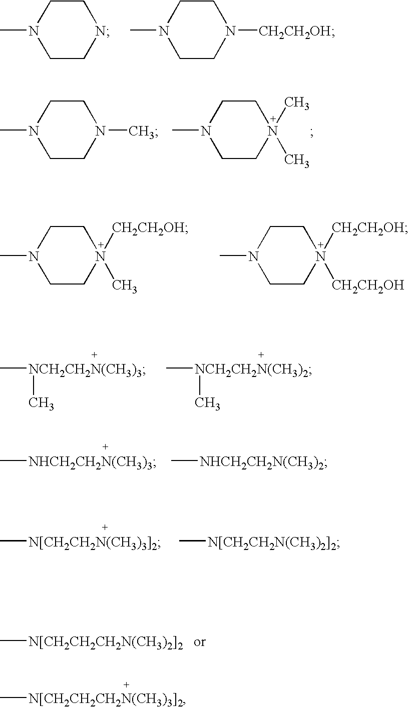
R′₃₁ and R′35 each independently of the other has the meanings given for R′₃₃ or is hydrogen and
A is F⁻; Cl⁻; Br⁻; I⁻; perchlorate; sulfate; nitrate; OH⁻; BF₄⁻; PF₆⁻ or carboxylate.

11. A particulate composition according to claim 1, wherein there is used as component (a) a bleach catalyst of formula (4′β) 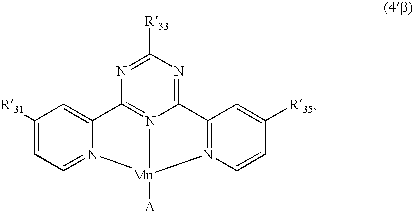
wherein
R′₃₃ is —OH; 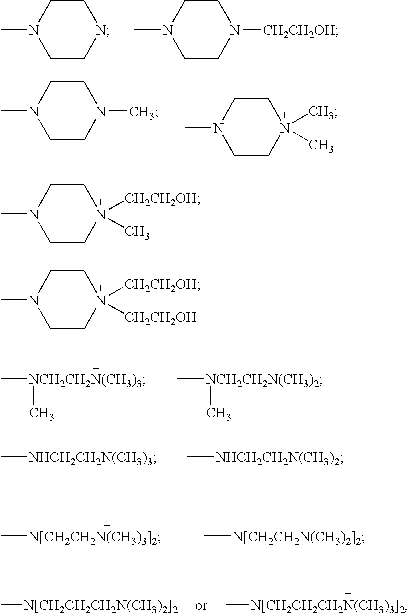
R′₃₁ and R′₃₅ each independently of the other has the meanings given for R′₃₃ or is hydrogen and
A is F⁻; Cl⁻; Br⁻; I⁻; perchlorate; sulfate; nitrate; OH⁻; BF₄⁻; PF₆⁻ or carboxylate.

12. A particulate composition according to claim 1, wherein there is used as component (b) at least one alkali metal and/or alkaline earth metal and/or aluminium carbonate, hydrogen carbonate, phosphate, polyphosphate, tripolyphosphate, sulfate, silicate, sulfite, borate, halide and/or pyrophosphate.

13. A particulate composition according to claim 1, wherein the compounds of component (c) have a melting point in the range from 30 to 120° C. or a glass transition temperature in the range from 30 to 120° C.

14. A particulate composition according to claim 1, wherein there is used as compound(s) of component (e) at least one compound from the group of the copolymers of acrylic acid with sulfonated stryenes; polyethylenesulfonic acids; sodium carboxymethyl cellulose; gelatin; polyacrylates and maltodextrin, and/or at least one dispersing agent that is neither meltable nor thermoplastic in the range up to 150° C. from the group of the condensation products of naphthalenesulfonic acids with formaldehyde; sodium salts of polymerised organic sulfonic acids; (mono-/di-)alkylnaphthalenesulfonates; polyalkylated polynuclear arylsulfonates; sodium salts of polymerised alkylbenzenesulfonic acids; lignosulfonates; oxylignosulfonates and condensation products of naphthalenesulfonic acid with a polychloromethyidiphenyl.

15. A particulate composition according to claim 1, wherein there is used as compound(s) of component (f) at least one compound from the group of the polycarboxylates; water-soluble polysiloxanes; aliphatic C₂-C₁₂polycarboxylic acids; calcium salts of saturated and unsaturated fatty acids; sawdust; paper fibres; activated carbon; natural fibres and natural fabric; cellulose materials; macroporous adsorber resins; crosslinked polyacrylic acid; highly disperse, solid polymer compounds formed by polymerisation, polycondensation or polyaddition reactions or by a combination of such reactions; aluminium oxide; magnesium oxide; and/or (layered) silicates.

16. A particulate composition according to claim 1, wherein the particulate composition is provided with a layer (coating).

17. A method of preparing a particulate composition according to claim 1, wherein component (a) is first of all ground and is then granulated together with the other components.

18. A method of bleaching stains or soiling on textile material in the context of a washing process, which comprises washing said textile material with a washing composition containing a particulate composition according to claim 1 together with a Peroxy compound.

19. A method to prevent the redeposition of migrating dyes during washing of textile material, which comprises washing said textile material with washing composition containing a particulate composition according to claim 1 together with a Peroxy compound.

20. A method for cleaning hard surfaces, which comprises washing said surfaces with a cleaning composition containing a particulate composition according to claim 1 together with a peroxy compound.

21. A method claim 18, whereby an antibacterial action is obtained.

22. A washing, cleaning, disinfecting or bleaching composition containing
I) from 0 to 50% by weight A) of at least one anionic surfactant and/or B) of at least one non-ionic surfactant,
II) from 0 to 70% by weight C) of at least one builder substance,
Ill) from 1 to 99% by weight D) of at least one peroxide or at least one peroxide-forming substance,
IV) (E) a particulate composition according claim 1 in an amount that gives a metal complex concentration in the liquor of from 0.05 to 100 mg/l of liquor when from 0.5 to 20 g/l of the particulate composition are added to the liquor, and
V) water to 100% by weight.

23. A peroxide-free or “peroxide-forming substance”-free washing, cleaning, disinfecting or bleaching composition containing
I) from 0 to 50% by weight A) of at least one anionic surfactant and/or B) of at least one non-ionic surfactant,
II) from 0 to 70% by weight C) of at least one builder substance,
III) (E) a particulate composition according to claim 1 in an amount that gives a metal complex concentration in the liquor of from 0.05 to 100 mg/l of liquor when from 0.5 to 20 g/l of the particulate composition are added to the liquor, and
IV) water to 100% by weight.

24. A method of preventing the redeposition of migrating dyes and of simultaneously bleaching stains or soiling on textile material, which comprises treating the textile material with a particulate composition according to claim 1.
